(19) United States
(12) Patent Application Publication
(10) Pub. No.: US 2026/0145250 A1
(43) Pub. Date: May 28, 2026

(54) PORTABLE BANDSAW STAND

(71) Applicant: MAKITA CORPORATION, Anjo-shi (JP)

(72) Inventors: Masanori HAYASHI, Anjo-shi (JP); Syuji AOYAMA, Anjo-shi (JP)

(73) Assignee: MAKITA CORPORATION, Anjo-shi (JP)

(21) Appl. No.: 19/381,139

(22) Filed: Nov. 6, 2025

(30) Foreign Application Priority Data
Nov. 22, 2024 (JP) 2024-203627
Apr. 22, 2025 (JP) 2025-070886

(51) Int. Cl. B23D 55/02; B23D 53/12; B23D 55/04; B23D 59/00

(52) U.S. Cl. CPC B23D 55/02; B23D 53/12; B23D 55/04; B23D 59/007

(57) ABSTRACT

A portable bandsaw stand, to which a portable bandsaw is attached, includes: a base; an attachment arm that is swingably supported about a swing fulcrum by the base and to which the portable bandsaw is attached; and a return device configured to automatically return the attachment arm to a top dead center.

### CROSS-REFERENCE TO RELATED APPLICATION(S)

The present application claims priority to and incorporates by reference the entire contents of Japanese Patent Application No. 2024-203627 filed in Japan on Nov. 22, 2024 and Japanese Patent Application No. 2025-070886 filed in Japan on Apr. 22, 2025.

### TECHNICAL FIELD

The techniques disclosed in the present teachings relate to a stand for a portable bandsaw.

### BACKGROUND

In the technical field related to a portable bandsaw, there is a known stand to which a portable bandsaw is attached, as disclosed in Japanese Laid-open Patent Publication No. 2023-009616. The portable bandsaw is swingably attached to the stand so as to move between a top dead center and a bottom dead center.

When the portable bandsaw is moved (swung) to the top dead center, in a case where a user of the portable bandsaw needs to lift the portable bandsaw by himself/herself, a burden on the user is high. When the burden on the user is high, there is a possibility that work efficiency is deteriorated and a work time is increased.

In addition, the stand includes a fence that supports a workpiece and a vise that fixes the workpiece. There is a demand for a technique capable of stably fixing the workpiece with satisfactory operability.

One non-limiting object of the present teachings is to reduce a burden on a user of a portable bandsaw.

Another non-limiting object of the present teachings is to stably fix a workpiece with satisfactory operability.

### SUMMARY OF THE INVENTION

The present teachings disclose a portable bandsaw stand to which a portable bandsaw is attached. In one aspect of the present teachings, a portable bandsaw stand may include: a base; an attachment arm that is swingably supported about a swing fulcrum by the base and to which the portable bandsaw is attached; and a return device configured to automatically return the attachment arm to a top dead center.

In another aspect of the present teachings, a portable bandsaw stand to which a portable bandsaw is attached, a portable bandsaw stand may include: a base; a fence that is provided on the base and has an abutment surface supporting a workpiece; and a vise that is provided on the base and fixes the workpiece. The abutment surface may face a counter-user side. The vise may be disposed on the counter-user side of the abutment surface, and may include a clamping rod, an abutment member that is connected to one end of the clamping rod and comes into contact with the workpiece, and an operation member that is connected to another end of the clamping rod. The abutment member may be disposed at a position closer to the abutment surface than the operation member.

According to the technique disclosed in the present teachings, a burden on a user of the portable bandsaw is reduced.

According to the technique disclosed in the present teachings, the workpiece is stably fixed with satisfactory operability.

### BRIEF DESCRIPTION OF THE DRAWINGS

FIG. 1 is a perspective view from a front-upper left side, illustrating a bandsaw according to an embodiment;

FIG. 2 is a view of the bandsaw according to the embodiment, as viewed from a right side;

FIG. 3 is an exploded view of the bandsaw according to the embodiment, as viewed from the right side;

FIG. 4 is a perspective view from a rear-upper left side, illustrating the bandsaw according to the embodiment;

FIG. 5 is a perspective view from a front-upper right side, illustrating a stand, according to the embodiment, to which the bandsaw is attached;

FIG. 6 is a perspective view from the rear-upper left side, illustrating the stand, according to the embodiment, to which the bandsaw is attached;

FIG. 7 is a perspective view from a rear-lower left side, illustrating the stand, according to the embodiment, to which the bandsaw is attached;

FIG. 8 is a view of the stand, according to the embodiment, to which the bandsaw is attached, as viewed from a left side;

FIG. 9 is a view of the stand, according to the embodiment, to which the bandsaw is attached, as viewed from the right side;

FIG. 10 is a view of the stand, according to the embodiment, to which the bandsaw is attached, as viewed from a front side;

FIG. 11 is a view of the stand, according to the embodiment, to which the bandsaw is attached, as viewed from behind;

FIG. 12 is a view of the stand, according to the embodiment, to which the bandsaw is attached, as viewed from above;

FIG. 13 is a view of the stand, according to the embodiment, to which the bandsaw is attached, as viewed from the left side;

FIG. 14 is a view of the stand, according to the embodiment, to which the bandsaw is attached, as viewed from the right side;

FIG. 15 is a view of the stand, according to the embodiment, to which the bandsaw is attached, as viewed from the front side;

FIG. 16 is a view of the stand, according to the embodiment, to which the bandsaw is attached, as viewed from behind;

FIG. 17 is a view of the stand, according to the embodiment, to which the bandsaw is attached, as viewed from above;

FIG. 18 is a sectional view illustrating a part of the stand according to the embodiment;

FIG. 19 is a sectional view illustrating a part of the stand according to the embodiment;

FIG. 20 is a sectional view illustrating a part of the stand according to the embodiment;

FIG. 21 is a perspective view from the front-upper right side, illustrating the stand according to the embodiment;

FIG. 22 is a perspective view from the rear-upper left side, illustrating the stand according to the embodiment;

FIG. 23 is an exploded perspective view from the rear-upper left side, illustrating the stand according to the embodiment;

FIG. 24 is a perspective view from the front-upper left side, illustrating a bandsaw according to an embodiment;

FIG. 25 is a view of the bandsaw according to the embodiment, as viewed from the right side;

FIG. 26 is an exploded view of the bandsaw according to the embodiment, as viewed from the right side;

FIG. 27 is a perspective view from the rear-upper left side, illustrating the bandsaw according to the embodiment;

FIG. 28 is a perspective view from the front-upper right side, illustrating a stand, according to the embodiment, to which the bandsaw is attached;

FIG. 29 is a perspective view from the rear-upper left side, illustrating the stand, according to the embodiment, to which the bandsaw is attached;

FIG. 30 is a perspective view from the rear-lower left side, illustrating the stand, according to the embodiment, to which the bandsaw is attached;

FIG. 31 is a view of the stand, according to the embodiment, to which the bandsaw is attached, as viewed from the left side;

FIG. 32 is a view of the stand, according to the embodiment, to which the bandsaw is attached, as viewed from the right side;

FIG. 33 is a view of the stand, according to the embodiment, to which the bandsaw is attached, as viewed from the front side;

FIG. 34 is a view of the stand, according to the embodiment, to which the bandsaw is attached, as viewed from behind;

FIG. 35 is a view of the stand, according to the embodiment, to which the bandsaw is attached, as viewed from above;

FIG. 36 is a view of the stand, according to the embodiment, to which the bandsaw is attached, as viewed from the left side;

FIG. 37 is a view of the stand, according to the embodiment, to which the bandsaw is attached, as viewed from the right side;

FIG. 38 is a view of the stand, according to the embodiment, to which the bandsaw is attached, as viewed from the front side;

FIG. 39 is a view of the stand, according to the embodiment, to which the bandsaw is attached, as viewed from behind;

FIG. 40 is a view of the stand, according to the embodiment, to which the bandsaw is attached, as viewed from above;

FIG. 41 is a sectional view illustrating a part of the stand according to the embodiment;

FIG. 42 is a sectional view illustrating a part of the stand according to the embodiment;

FIG. 43 is a sectional view illustrating a part of the stand according to the embodiment;

FIG. 44 is a perspective view from the front-upper right side, illustrating the stand according to the embodiment;

FIG. 45 is a perspective view from the rear-upper left side, illustrating the stand according to the embodiment;

FIG. 46 is an exploded perspective view from the rear-upper left side, illustrating the stand according to the embodiment;

FIG. 47 is a view of a part of the stand according to the embodiment, as viewed from the left side;

FIG. 48 is a sectional view illustrating a part of the stand according to the embodiment; and

FIG. 49 is a sectional view illustrating a part of the stand according to the embodiment.

### DETAILED DESCRIPTION OF PREFERRED EMBODIMENTS

In one or more embodiment, a portable bandsaw stand, to which a portable bandsaw is attached, may include: a base; an attachment arm that is swingably supported about a swing fulcrum by the base and to which the portable bandsaw is attached; and a return device configured to automatically return the attachment arm to a top dead center.

With the above configuration, when the bandsaw is moved to the top dead center, it is not necessary for the user of the bandsaw to lift the bandsaw by himself/herself. Hence, a burden on the user is reduced. In addition, since it is not necessary for the user to lift the bandsaw by himself/herself, the user can quickly shift to other work. Hence, deterioration of work efficiency is inhibited, and an increase in work time is inhibited.

In one or more embodiment, the return device may include a spring that is interposed between the base and the attachment arm. The attachment arm may be held at the top dead center by urging force of the spring.

With the above configuration, by the urging force of the spring, the attachment arm is automatically returned to the top dead center, and the position of the attachment arm is reasonably held at the top dead center. The position of the bandsaw is held at the top dead center, for example, without using a lock mechanism.

In one or more embodiment, the spring may include a torsion spring. A swing support shaft of the attachment arm may be inserted into a coil portion of the torsion spring. One arm portion of the torsion spring may press the base, and the other arm portion of the torsion spring may press the attachment arm up to the top dead center.

With the above configuration, assemblability during manufacture of the stand is enhanced. In addition, performance when the bandsaw is attached to the stand is also enhanced.

In one or more embodiment, the portable bandsaw may include a drive wheel that is rotated by a motor, a driven wheel, and a blade that is stretched between the drive wheel and the driven wheel. The driven wheel may be disposed on a counter-user side of the drive wheel. The swing fulcrum may be disposed on the counter-user side of the drive wheel.

With the above configuration, the drive wheel is disposed on the front side (user side) in both the attached state and the normal use state. The user can carry out work with the same operation in both the attached state and the normal use state. The attached state refers to the state of using the bandsaw attached to the stand. The normal use refers to the state of using the bandsaw removed from the stand (i.e., using the bandsaw without being attached to the stand).

In one or more embodiment, the portable bandsaw may include a housing that accommodates the drive wheel and the driven wheel, and a handle that is fixed to the housing. In a left-right direction parallel to an axis of the swing fulcrum, a position of a cutting portion of the blade with respect to the handle in an attached state in which the portable bandsaw is attached to the stand may be the same as a position of a cutting portion of the blade with respect to the handle in a normal use state in which the portable bandsaw is normally used.

With the above configuration, the user can carry out work with the same operation in both the attached state and the normal use state.

In one or more embodiment, the cutting portion of the blade is disposed on a left side of the handle in both the attached state and the normal use state.

With the above configuration, when the user grips the handle with the right hand, the user can easily see the cutting portion of the blade, so that the deterioration of performance is inhibited.

In one or more embodiment, the attachment arm may include a cylindrical portion that is disposed around the swing fulcrum, a first arm portion that extends from the cylindrical portion to a user side, and a second arm portion that extends upward from the cylindrical portion. The portable bandsaw stand may include: a first fastener that fixes the first arm portion to the portable bandsaw; and a second fastener that fixes the second arm portion to the portable bandsaw.

With the above configuration, the bandsaw is stably fixed to the stand by the first fastener and the second fastener that are spaced apart from each other.

In one or more embodiment, at least one of the first fastener or the second fastener may be a thumb screw.

With the above configuration, the user can attach and detach the bandsaw to and from the stand without using a tool. The thumb screw is a screw capable of being tightened by a user with fingers. Both the first fastener and the second fastener may be thumb screws. One of the first fastener and the second fastener may be a thumb screw, and the other may be a and the other of the first fastener and the second fastener may be a normal screw to be tightened using a tool.

In one or more embodiment, the stand may include: a vise that is provided on the base and fixes a workpiece; and a fence that is provided on the base and supports the workpiece. An abutment surface, of the fence, facing the workpiece may face a counter-user side. The vise may be disposed on the counter-user side of the abutment surface.

With the above configuration, when cutting the workpiece with the blade, if the workpiece moves to the front side (user side) due to force of the blade transmitted in the direction of the user, the workpiece positioned against the fence can be appropriately supported by the abutment surface, of the fence, facing the rear side (counter-user side). The workpiece can be appropriately fixed by the vise disposed rearward (counter-user side) of the abutment surface of the fence.

In one or more embodiment, a portable bandsaw stand, to which a portable bandsaw is attached, may include: a base; and an attachment arm that is swingably supported about a swing fulcrum by the base and to which the portable bandsaw is attached. The portable bandsaw may include a drive wheel that is rotated by a motor, a driven wheel, a blade that is stretched between the drive wheel and the driven wheel, a housing that accommodates the drive wheel and the driven wheel, and a battery mounting portion on which a battery pack is mounted. The driven wheel may be disposed on a counter-user side of the drive wheel. The swing fulcrum may be disposed on the counter-user side of the drive wheel. The battery pack mounted on the battery mounting portion may be disposed on a user side of a position that is half a distance from the swing fulcrum to a user-side end of the housing.

With the above configuration, when the bandsaw is moved to the bottom dead center, the weight of the battery pack facilitates the movement of the bandsaw to the bottom dead center. Hence, the burden on the user is reduced. In addition, the user can smoothly attach and detach the battery pack to and from the battery mounting portion.

In one or more embodiment, the portable bandsaw may include a handle that is fixed to the housing. The battery mounting portion may be provided on the user-side end of the handle.

With the above configuration, since the battery pack, which is a heavy object, is disposed at the user-side end of the handle, an operating feeling when the user moves the bandsaw to the bottom dead center is improved.

In one or more embodiment, a portable bandsaw stand, to which a portable bandsaw is attached, may include: a base; an attachment arm including a cylindrical portion that is swingably supported about a swing fulcrum by the base and is disposed around the swing fulcrum, a first arm portion that extends from the cylindrical portion to a user side, and a second arm portion that extends upward from the cylindrical portion; a first fastener that fixes the first arm portion to the portable bandsaw; and a second fastener that fixes the second arm portion to the portable bandsaw.

With the above configuration, the bandsaw is stably fixed to the stand by the first fastener and the second fastener that are spaced apart from each other.

In one or more embodiment, the bandsaw may further include: a support member that is fixed to the base; and a lock member that is movably supported by the support member and fixes the attachment arm by being inserted into at least a part of the first arm portion.

With the above configuration, the position of the attachment arm is fixed by the lock member. In addition, an increase in size of a lock mechanism including the support member and the lock member 38 inhibited.

In one or more embodiment, the first arm portion may have an insertion hole for a bottom dead center. The attachment arm may be fixed at the bottom dead center by inserting the lock member into the insertion hole for the bottom dead center.

With the above configuration, the position of the attachment arm is fixed at the bottom dead center by the lock member. In addition, an increase in size of the lock mechanism including the support member and the lock member is inhibited.

In one or more embodiment, the first arm portion may have an insertion hole for a bottom dead center and an insertion hole for a top dead center. The attachment arm may be fixed at the bottom dead center by inserting the lock member into the insertion hole for the bottom dead center. The attachment arm may be fixed at the top dead center by inserting the lock member into the insertion hole for the top dead center.

With the above configuration, the position of the attachment arm is fixed at either the bottom dead center or the top dead center by the lock member. The position of the attachment arm is fixed at the top dead center, whereby the user can carry out, for example, replacement of the blade with new one with the bandsaw 1 attached to the stand. The position of the attachment arm is fixed at the top dead center, whereby unintended downward movement of the bandsaw is inhibited when replacing the blade. In addition, an increase in size of the lock mechanism including the support member and the lock member is inhibited.

In one or more embodiment, the first arm portion may include a storage portion that stores at least a part of the first fastener.

With the above configuration, a dead space of the first arm portion is effectively utilized.

In one or more embodiment, an outer shape of the base may be rectangular in plan view.

With the above configuration, an increase in size of the stand is inhibited. The user can store the stand, for example, in a narrow space.

In one or more embodiment, the base may be made of a drawn steel plate. The attachment arm may be made of a die-cast alloy.

With the above configuration, both lightweight and high strength of stand 30 can be achieved.

In one or more embodiment, a portable bandsaw stand, to which a portable bandsaw is attached, may include: a base; a fence that is provided on the base and has an abutment surface supporting a workpiece; and a vise that is provided on the base and fixes the workpiece. The abutment surface may face a counter-user side. The vise may be disposed on the counter-user side of the abutment surface, and include a clamping rod, an abutment member that is connected to one end of the clamping rod and comes into contact with the workpiece, and an operation member that is connected to another end of the clamping rod. The abutment member may be disposed at a position closer to the abutment surface than the operation member.

With the above configuration, when cutting the workpiece with the blade of the bandsaw 1, if the workpiece moves to the user side due to force of the blade transmitted in the direction of the user, the workpiece is appropriately supported by the abutment surface, of the fence, facing the counter-user side. The workpiece W positioned against the fence is appropriately fixed by the vise disposed on the counter-user side of the abutment surface of the fence. Since the abutment member of the vise is disposed on the user side of the operation member, the workpiece is pressed against the abutment surface of the fence to be appropriately fixed. The user can operate the operation member with satisfactory operability.

In one or more embodiment, an angle formed by the abutment surface and the clamping rod may be 1 degree or more and 45 degrees or less.

With the above configuration, the user can operate the operation member with satisfactory operability, and the workpiece is appropriately fixed by the vise. When the angle formed by the abutment surface and the clamping rod is less than 1 degree, there may be a possibility that the force of the abutment member pressing the workpiece against the abutment surface of the fence is weakened. When the force by which the workpiece is pressed against the abutment surface of the fence is weakened, a possibility increases that the workpiece is not appropriately fixed. When the angle formed by the abutment surface and the clamping rod exceeds 45 degrees, there is a possibility that the distance between the user positioning on the user side of the stand and the operation member is lengthened. When the distance between the user and the operation member is lengthened, there is a possibility that the user has difficulty in operating the operation member with satisfactory operability. The angle formed by the abutment surface and the clamping rod is set to 1 degree or more and 45 degrees or less, whereby the user can operate the operation member with satisfactory operability, and the workpiece is appropriately fixed.

In one or more embodiment, an angle formed by the abutment surface and the clamping rod may be 5 degrees or more and 20 degrees or less.

With the above configuration, the user can operate the operation member with satisfactory operability, and the workpiece is appropriately fixed by the vise. When the angle formed by the abutment surface and the clamping rod is less than 5 degrees, there may be the possibility that the force of the abutment member pressing the workpiece against the abutment surface of the fence is weakened. When the force by which the workpiece is pressed against the abutment surface of the fence is weakened, the possibility increases that the workpiece is not appropriately fixed. When the angle formed by the abutment surface and the clamping rod exceeds 20 degrees, there is the possibility that the distance between the user positioning on the user side of the stand and the operation member is lengthened. When the distance between the user and the operation member is lengthened, there is the possibility that the user has difficulty in operating the operation member with satisfactory operability. The angle formed by the abutment surface and the clamping rod is set to 5 degrees or more and 20 degrees or less, whereby the user can operate the operation member with satisfactory operability, and the workpiece is appropriately fixed.

In one or more embodiment, the vise may be fixed to an upper surface of the base, and may be attachable to a support table having an upper surface that supports the workpiece.

With the above configuration, the workpiece is more appropriately fixed by the abutment surface of the fence, the abutment member of the vise, and the support table.

In one or more embodiment, the vise may include a vise arm that supports the clamping rod, and a guide rod that supports the vise arm. The guide rod may be inclined in the same direction as the clamping rod is.

With the above configuration, a moment acting on the guide rod from the vise arm is inhibited from becoming excessive. Since the moment acting on the guide rod is small, the force by which the workpiece is pressed against the abutment surface of the fence is inhibited from changing. Hence, the workpiece is appropriately fixed.

In one or more embodiment, the support table may include a rod support portion to which the guide rod is attached.

With the above configuration, the number of components interposed between the upper surface of the support table and the abutment member is inhibited from becoming excessive. The number of components is lessened, whereby the workpiece is more appropriately fixed by the abutment surface of the fence, the abutment member of the vise, and the support table.

In one or more embodiment, an angle formed by the abutment surface and the guide rod may be 5 degrees or more and 20 degrees or less.

With the above configuration, the user can operate the operation member with satisfactory operability, and the workpiece is appropriately fixed by the vise.

In one or more embodiment, the abutment member may be an elastic body made of rubber or synthetic resin.

With the above configuration, the abutment member can deform in conformity with the shape of the workpiece.

In one or more embodiment, a facing portion, of the abutment member, facing the workpiece may include a recess that is recessed so as to be away from the workpiece.

With the above configuration, the abutment member can deform in conformity with the outer shape of the workpiece.

In one or more embodiment, an inner surface of the recess may have a curved shape.

With the above configuration, the abutment member can deform in conformity with the outer shape of the workpiece.

In one or more embodiment, a rubber hardness of the abutment member may be 80 or more and 90 or less.

With the above configuration, the abutment member can deform suitably in conformity with the shape of the workpiece.

Hereinafter, embodiments according to the present disclosure will be described with reference to the drawings. In the embodiments, positional relations of portions will be described using the terms of “front”, “rear”, “left”, “right”, “up”, and “down”. These terms indicate relative positions or directions with respect to the center of a stand 30 (portable bandsaw stand). In addition, in the embodiments, a virtual axis parallel to the front-rear direction is referred to as a front-rear axis as needed, a virtual axis parallel to the left-right direction is referred to as a left-right axis as needed, and a virtual axis parallel to the up-down direction is referred to as an up-down axis as needed.

As will be described later, when using a bandsaw 1 (portable bandsaw) attached to the stand 30, a user of the bandsaw 1 positions on the front side of the stand 30 and carries out work. In the embodiments, the front side is a user side where the user positions. The rear side is a counter-user side, which is the opposite side of the front side.

### First Embodiment

A first embodiment will be described.

### Bandsaw

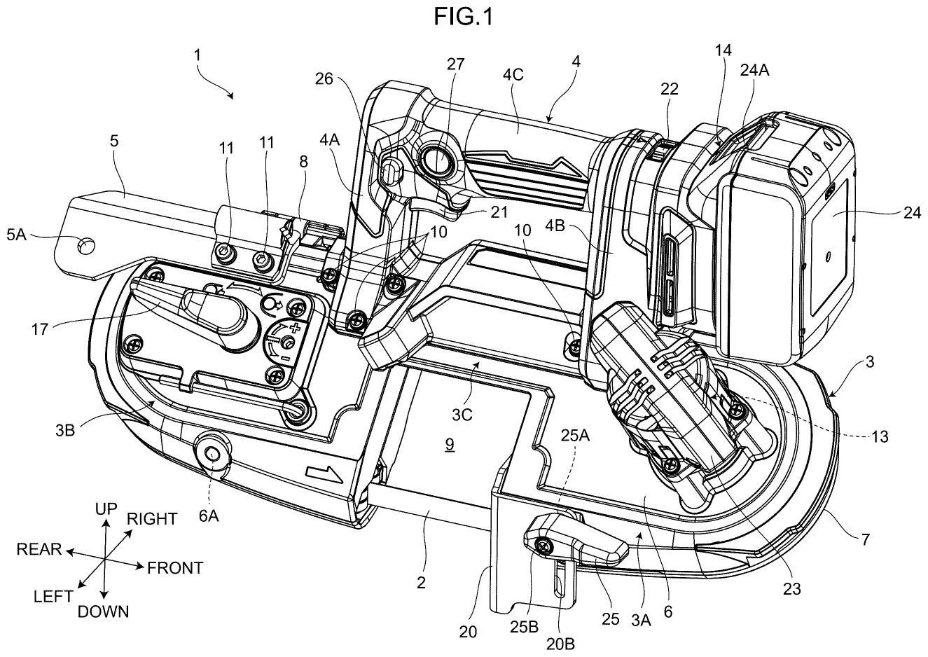

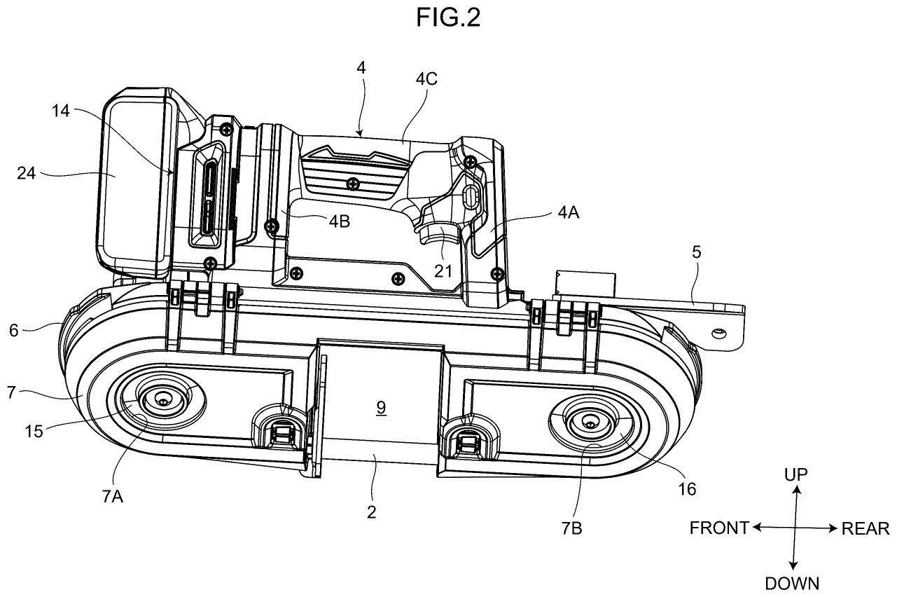

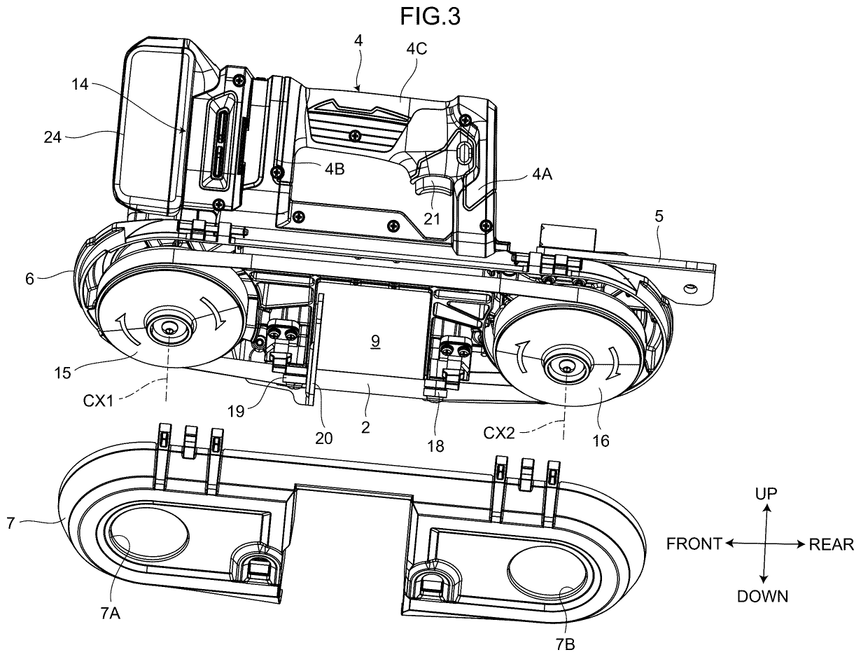

FIG. 1 is a perspective view from the front-upper left side, illustrating a bandsaw 1 according to the embodiment. FIG. 2 is a view of the bandsaw 1 according to the embodiment, as viewed from the right side. FIG. 3 is an exploded view of the bandsaw 1 according to the embodiment, as viewed from the right side. Arrows indicating “front”, “rear”, “left”, “right”, “up”, and “down” in FIGS. 1, 2, and 3 indicate directions when it is assumed that the bandsaw 1 is positioned at a bottom dead center of an attachment arm 34 described later with the bandsaw 1 attached to the attachment arm 34.

The bandsaw 1 is a kind of power tool using an electric motor as a power source. The bandsaw 1 refers to a power tool that cuts a workpiece W, which is a cutting target, by rotating a blade 2 having a band shape. In the embodiment, the bandsaw 1 is a portable bandsaw. A user of the bandsaw 1 can carry the bandsaw 1. The user of the bandsaw 1 can cut the workpiece W while holding the bandsaw 1 by his/her hand.

The bandsaw 1 includes a housing 3, a handle 4, and a plate 5.

The housing 3 is long in the front-rear direction. The housing 3 includes a base housing 6 and a cover housing 7. The base housing 6 is disposed above the cover housing 7. The base housing 6 and the cover housing 7 are arranged so as to overlap each other. The base housing 6 is made of metal. Aluminum and magnesium are exemplified as the metal forming the base housing 6. The cover housing 7 is made of synthetic resin. A polycarbonate resin and a polyamide resin are exemplified as the synthetic resin forming the cover housing 7.

An upper surface of the base housing 6 is inclined upward toward the right with the bandsaw 1 attached to the attachment arm 34, which will be described later and with the attachment arm 34 positioned at the bottom dead center. An upper-right portion of the base housing 6 and an upper-right portion of the cover housing 7 are connected to each other via a hinge 8. A pivot shaft of the hinge 8 extends in the front-rear direction. An accommodation space is defined between the base housing 6 and the cover housing 7.

An opening 9 is provided in a central portion of the housing 3 in the front-rear direction. The opening 9 is formed so as to be recessed from a lower-left end of the housing 3 toward the upper right.

The handle 4 is gripped by the user of the bandsaw 1. The handle 4 is fixed to the housing 3. The handle 4 is fixed to an upper portion of the base housing 6 by a plurality of screws 10. The handle 4 includes: a first portion 4A that is fixed to a given portion, of the base housing 6, rearward of the opening 9; a second portion 4B that is fixed to a given portion, of the base housing 6, forward of the opening 9; and a third portion 4C that joins the first portion 4A and the second portion 4B. Each of the first portion 4A and the second portion 4B is provided so as to extend upward from the base housing 6. The third portion 4C is provided so as to join an upper end of the first portion 4A and an upper end of the second portion 4B.

The plate 5 is fixed to the housing 3. The plate 5 is fixed to the upper portion of the base housing 6 by a plurality of screws 11. The plate 5 is disposed rearward of the handle 4. The plate 5 is long in the front-rear direction. A front end of the plate 5 is fixed to the base housing 6 by the two screws 11. A rear end of the plate 5 is disposed rearward of a rear end of the housing 3. The plate 5 is made of metal. Iron is exemplified as the metal forming the plate 5.

The bandsaw 1 includes a motor 13, a battery mounting portion 14, a drive wheel 15, a driven wheel 16, the blade 2, a tension adjustment lever 17, rear guide rollers 18, front guide rollers 19, a stopper plate 20, a main switch 21, a variable speed dial 22, and a light 42.

The motor 13 is a power source of the bandsaw 1. The motor 13 is an electric motor. The motor 13 is accommodated in a motor case 23. The motor case 23 is fixed to a given portion, of the base housing 6, forward of the opening 9. The motor case 23 is provided so as to protrude from the upper surface of the base housing 6 toward the upper left. The motor 13 is an inner rotor brushless motor.

The battery mounting portion 14 is connected to a battery pack 24. The battery pack 24 is mounted on the battery mounting portion 14. The battery mounting portion 14 is provided on a front end (user-side end) of the handle 4. The battery mounting portion 14 is provided on a front portion of the second portion 4B of the handle 4. The battery pack 24 is a power source of the bandsaw 1. The battery pack 24 includes a rechargeable battery. The battery pack 24 supplies direct current to the bandsaw 1. The motor 13 is driven by electric power supplied from the battery pack 24.

The battery pack 24 is fixed to the battery mounting portion 14 with a lock mechanism (not illustrated), in a state of being mounted on the battery mounting portion 14. The battery pack 24 is movable in the up-down direction with respect to the battery mounting portion 14. The battery mounting portion 14 includes a guide mechanism that guides the battery pack 24 in the up-down direction. The battery pack 24 includes an unlock button 24A that releases the fixation with the lock mechanism. The unlock button 24A is operated, whereby the fixation of the battery pack 24 by the lock mechanism is released. The unlock button 24A is disposed on an upper portion of the battery pack 24 with the battery pack 24 mounted on the battery mounting portion 14. The battery pack 24 is removed from the battery mounting portion 14 by moving the battery pack 24 upward after the unlock button 24A is operated in the state in which the battery pack 24 is mounted on the battery mounting portion 14. The battery pack 24 is mounted on the battery mounting portion 14 by moving the battery pack 24 so as to slide downward with respect to the battery mounting portion 14.

Each of the drive wheel 15 and the driven wheel 16 is accommodated in the housing 3. The drive wheel 15 is rotated by the motor 13. The drive wheel 15 is disposed forward of the opening 9. The driven wheel 16 is disposed rearward of the opening 9. The driven wheel 16 is disposed rearward (counter-user side) of the drive wheel 15.

As illustrated in FIG. 1, the housing 3 includes a front-side accommodation portion 3A, a rear-side accommodation portion 3B, and a bridge 3C. The front-side accommodation portion 3A is disposed forward of the rear-side accommodation portion 3B. The bridge 3C is disposed between the front-side accommodation portion 3A and the rear-side accommodation portion 3B in the front-rear direction. The front-side accommodation portion 3A is formed by a front portion of the base housing 6 and a front portion of the cover housing 7. The rear-side accommodation portion 3B is formed by a rear portion of the base housing 6 and a rear portion of the cover housing 7. The bridge 3C is formed by a central portion of the base housing 6 and a central portion of the cover housing 7. The drive wheel 15 is accommodated in the front-side accommodation portion 3A. The driven wheel 16 is accommodated in the rear-side accommodation portion 3B. The bridge 3C is disposed so as to join an upper portion of the front-side accommodation portion 3A and an upper portion of the rear-side accommodation portion 3B. The opening 9 is provided between a rear portion of the front-side accommodation portion 3A, a front portion of the rear-side accommodation portion 3B, and a lower portion of the bridge 3C. The opening 9 is provided below the bridge 3C.

The drive wheel 15 is partly exposed through an opening 7A provided in the cover housing 7. The driven wheel 16 is partly exposed through an opening 7B provided in the cover housing 7. Each of the drive wheel 15 and the driven wheel 16 is rotatably supported by the base housing 6. The drive wheel 15 rotates about a first rotation axis CX1. The driven wheel 16 rotates about a second rotation axis CX2. The first rotation axis CX1 and the second rotation axis CX2 are parallel. Each of the first rotation axis CX1 and the second rotation axis CX2 is inclined upward toward the left.

The blade 2 is stretched between (tensioned on) the drive wheel 15 and the driven wheel 16. The blade 2 is annular. The blade 2 is stretched in the front-rear direction by the drive wheel 15 and the driven wheel 16. At least a part of the blade 2 is disposed in the opening 9. The workpiece W is cut with the blade 2 disposed in the opening 9. The blade 2 is twisted near a boundary of the opening 9. In the opening 9, each of a left surface and a right surface of the blade 2 is orthogonal to the left-right axis.

The drive wheel 15 is connected to a rotor shaft of the motor 13. The drive wheel 15 is rotated by rotational force generated by the motor 13. When the drive wheel 15 is rotated about the first rotation axis CX1 by the motor 13, the blade 2 is rotated while being supported by each of the drive wheel 15 and the driven wheel 16. The driven wheel 16 rotates about the second rotation axis CX2 with the blade 2 stretched between the wheels, in accordance with the rotation of the drive wheel 15.

The tension adjustment lever 17 is operated to adjust tension of the blade 2. The tension adjustment lever 17 is connected to the driven wheel 16. The tension adjustment lever 17 is operated, whereby the driven wheel 16 moves in the front-rear direction. The driven wheel 16 moves in the front-rear direction, whereby the tension of the blade 2 is adjusted.

The rear guide rollers 18 guide the blade 2. The rear guide rollers 18 are rotatably supported by the base housing 6 so as to face the opening 9. The rear guide rollers 18 are disposed rearward of the opening 9. A pair of the rear guide rollers 18 is provided so as to sandwich the blade 2 in the left-right direction. Rotation axes of the rear guide rollers 18 are parallel to the up-down axis.

The front guide rollers 19 guide the blade 2. The front guide rollers 19 are rotatably supported by the base housing 6 so as to face the opening 9. The front guide rollers 19 are disposed forward of the opening 9. A pair of the front guide rollers 19 is provided so as to sandwich the blade 2 in the left-right direction. Rotation axes of the front guide rollers 19 are parallel to the up-down axis.

The blade 2 moves from the rear guide rollers 18 toward the front guide rollers 19 in the opening 9. The blade 2 moves forward (user side) in the opening 9. The drive wheel 15 rotates such that the blade 2 moves forward in the opening 9.

In a normal use state, the stopper plate 20 supports the workpiece W. The normal use state refers to a state of using the bandsaw 1 removed from the stand 30 (i.e., using the bandsaw without being attached to the stand). The normal use state refers to a state in which the user cuts the workpiece W while holding the bandsaw 1 in his/her hand. In the normal use, the user positions (stands) on the front side of the bandsaw 1 and carries out work while gripping the handle 4 with the right hand. In the normal use state, the stopper plate 20 supports the workpiece W from the front side.

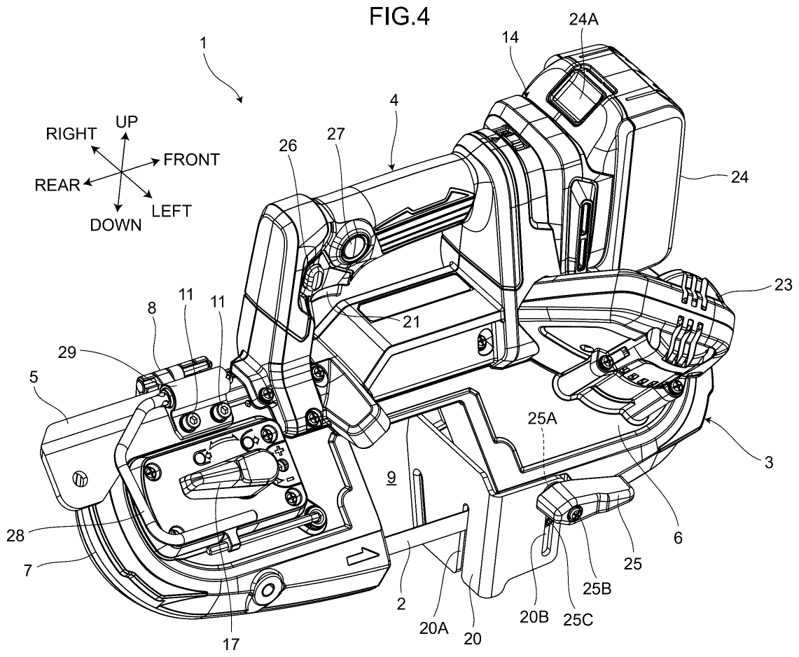

The stopper plate 20 is supported by the base housing 6. The stopper plate 20 is disposed at a front portion of the opening 9 so as to face the opening 9. The blade 2 rotates so as to move from the rear guide rollers 18 to the front guide rollers 19 in the opening 9. In the normal use state, the stopper plate 20 supports the workpiece W from the front side. The stopper plate 20 inhibits the workpiece W from moving in response to the rotation of the blade 2. As illustrated in FIG. 4, the stopper plate 20 has a slit 20A that is long in the up-down direction. The blade 2 passes through the slit 20A.

The stopper plate 20 is fixed to the base housing 6 by a fixing lever 25. The fixing lever 25 is connected to a left portion of the base housing 6 via a pivot member 25A. The fixing lever 25 and the pivot member 25A are fixed by a screw 25B. The pivot member 25A is inserted into a slit 20B provided in the stopper plate 20. The slit 20B is long in the up-down direction. When turning the fixing lever 25 in one direction, the stopper plate 20 is sandwiched and secured between the fixing lever 25 and the base housing 6, and the stopper plate 20 is fixed to the base housing 6. When turning the fixing lever 25 in the other direction, the fixation of the stopper plate 20 is released.

The position of the stopper plate 20 in the up-down direction with respect to the base housing 6 is adjustable. As illustrated in FIG. 4, a stopper pin 25C is fixed to the base housing 6. The stopper pin 25C is a setscrew. At least a part of the stopper pin 25C is disposed in the slit 20B. The stopper plate 20 is movable in the up-down direction while the slit 20B is guided by the pivot member 25A and the stopper pin 25C. After the stopper plate 20 is moved in the up-down direction in a state in which the fixation of the stopper plate 20 is released, the fixing lever 25 is turned in the one direction, whereby the stopper plate 20 is fixed at a certain position in the up-down direction.

The main switch 21 is operated to drive or stop the motor 13. The main switch 21 is disposed on the handle 4. In the embodiment, the main switch 21 is provided so as to protrude downward from a lower portion of a rear portion of the third portion 4C. The main switch 21 is pulled to move upward, whereby the motor 13 is driven.

A lock-off operation member 26 and a lock-on operation member 27 are arranged near the main switch 21. The lock-off operation member 26 is operable to place the operation of the main switch 21 from a blocked state to an allowed state. The lock-off operation member 26 is disposed on an upper portion of the first portion 4A. When the lock-off operation member 26 is not operated, the operation of the main switch 21 is blocked. The lock-off operation member 26 is pushed, whereby the operation of the main switch 21 is changed from the blocked state to the allowed state. Once the user pushes the lock-off operation member 26, the user is allowed to pull the main switch 21.

The lock-on operation member 27 is operable to maintain the pull operation of the main switch 21. The lock-on operation member 27 is disposed on the rear portion of the third portion 4C. After the main switch 21 is pulled, the lock-on operation member 27 is pushed to maintain the pull operation. After the main switch 21 is pulled and then the lock-on operation member 27 is pushed, the motor 13 can be continuously driven even when the pull operation on the main switch 21 is released (i.e., even when the user removes the finger from the main switch 21).

The variable speed dial 22 is operable to adjust a rotation speed of the motor 13. The variable speed dial 22 is disposed on an upper portion of the handle 4.

The light 42 illuminates the workpiece W and the blade 2. The light 42 is disposed, at the left portion of the base housing 6, rearward of the central portion in the front-rear direction. The light 42 is configured with an LED.

FIG. 4 is a perspective view from the rear-upper left side, illustrating the bandsaw 1 according to the embodiment. As illustrated in FIG. 4, a hook 28 is attachable to the plate 5. The hook 28 is supported by a hook support member 29. The hook 28 is rotatably supported by the hook support member 29. The hook support member 29 is fixed to the plate 5 by screws 11. With the screws 11, the hook support member 29 and the plate 5 are fastened together to the base housing 6. The plate 5 is fastened together with the hook support member 29.

### Stand

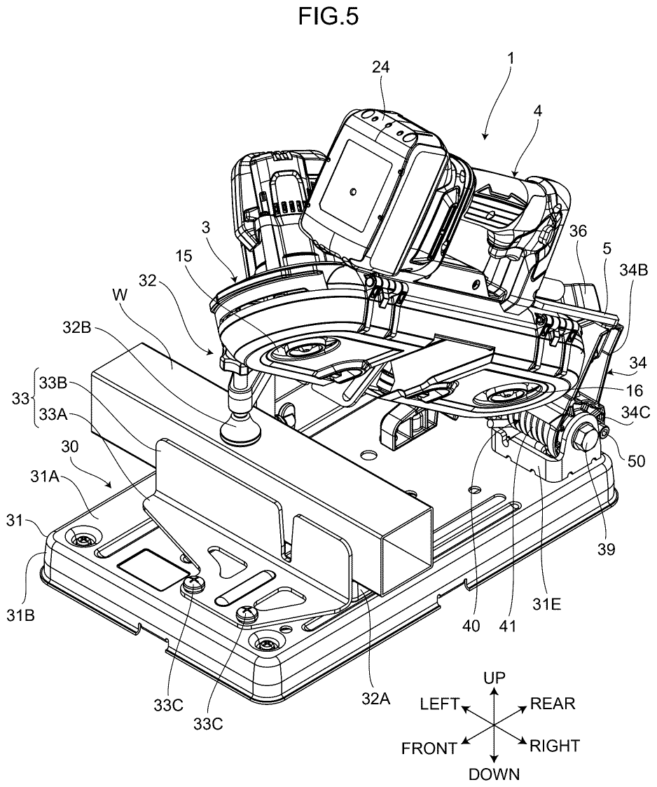

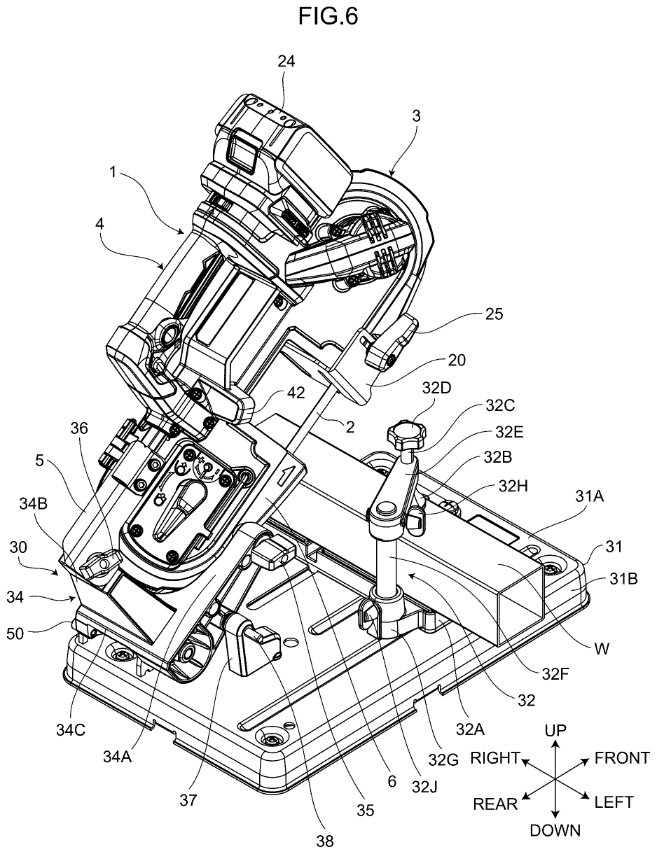

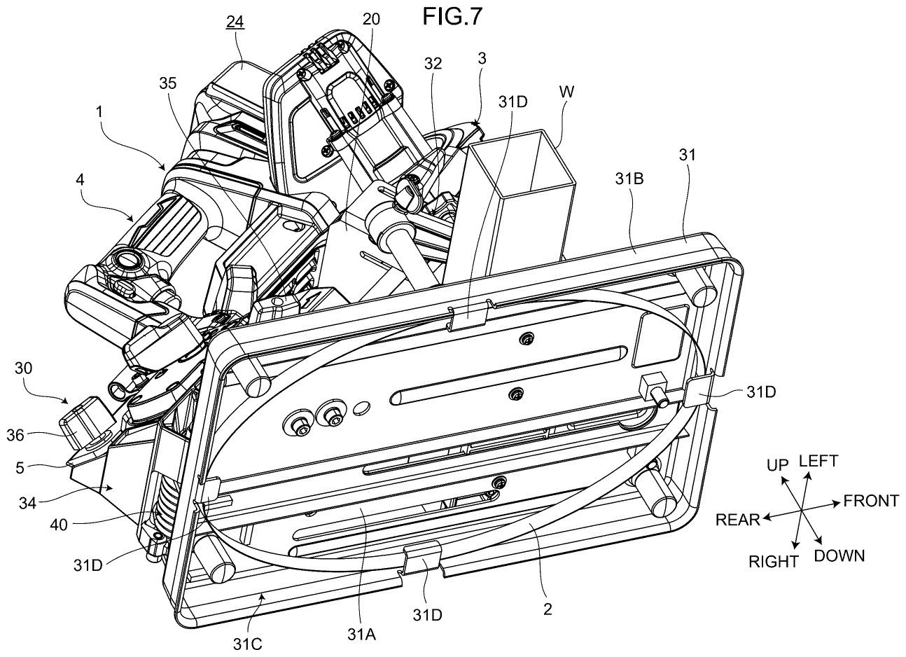

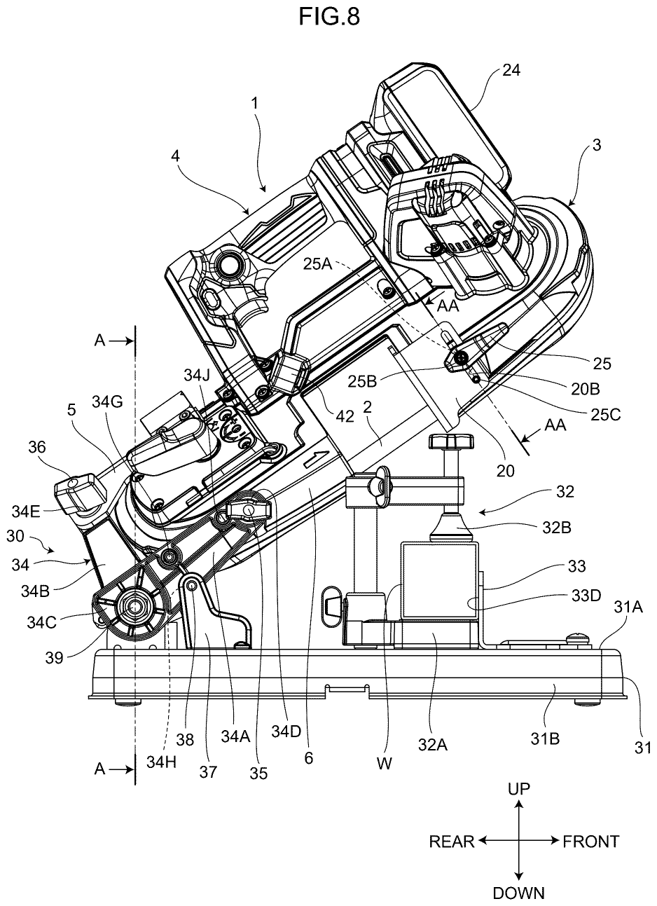

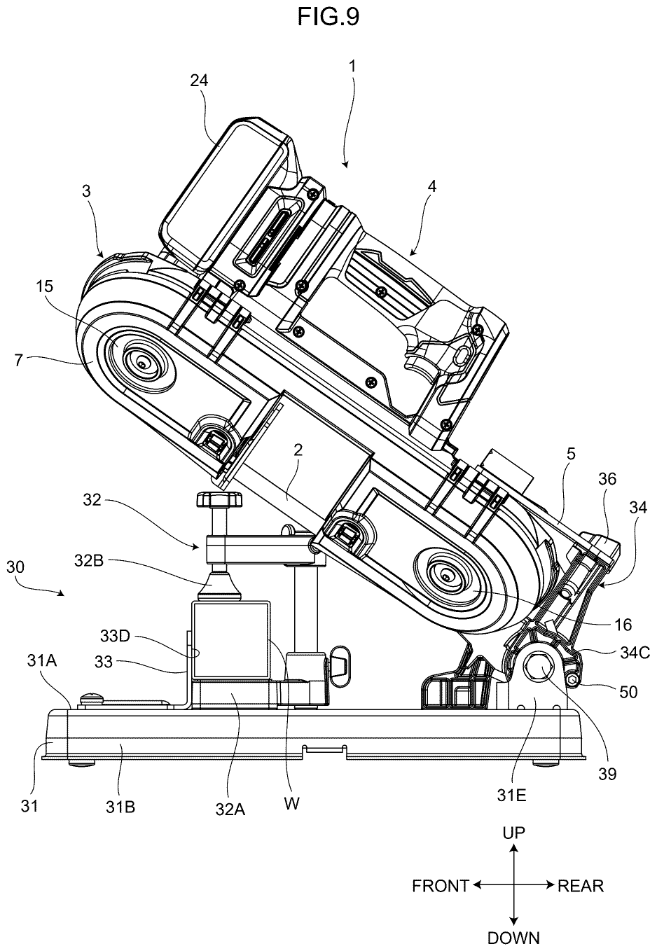

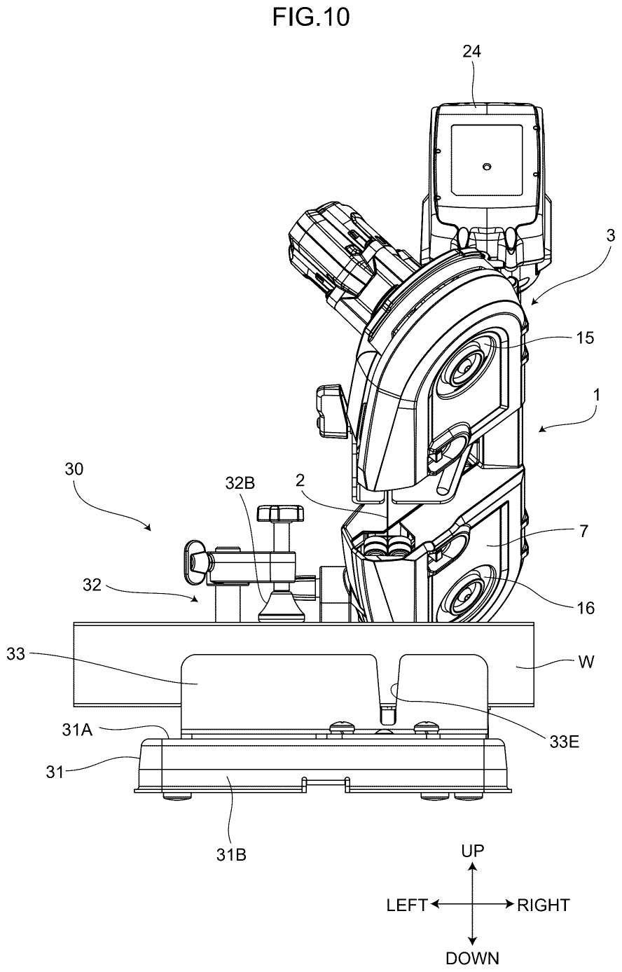

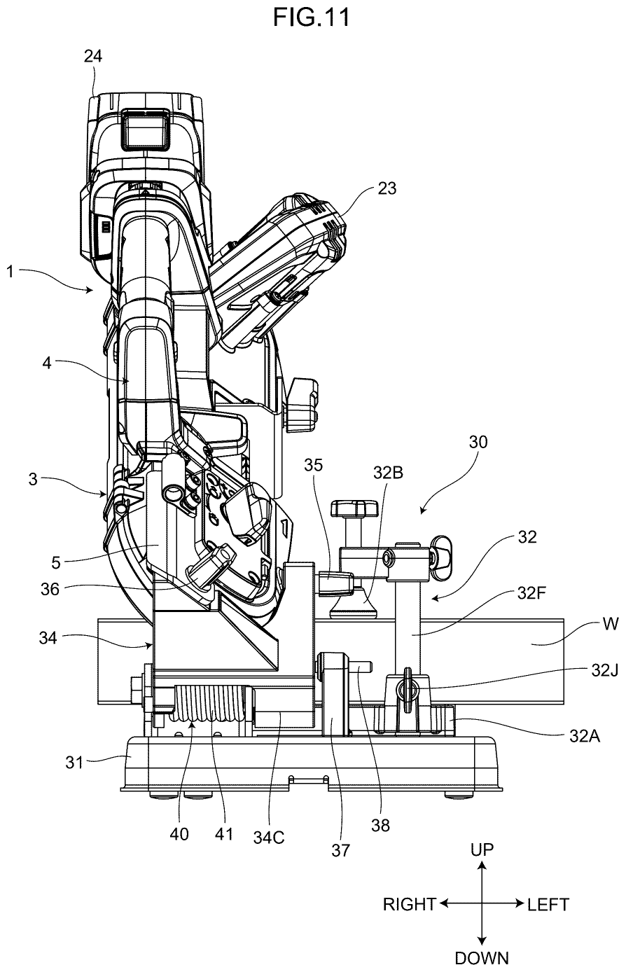

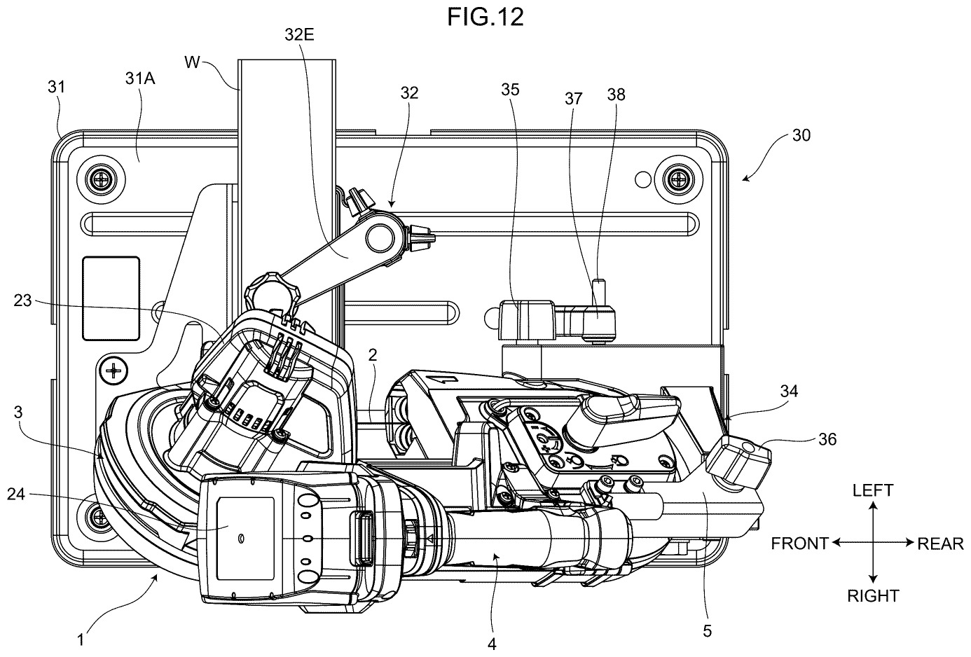

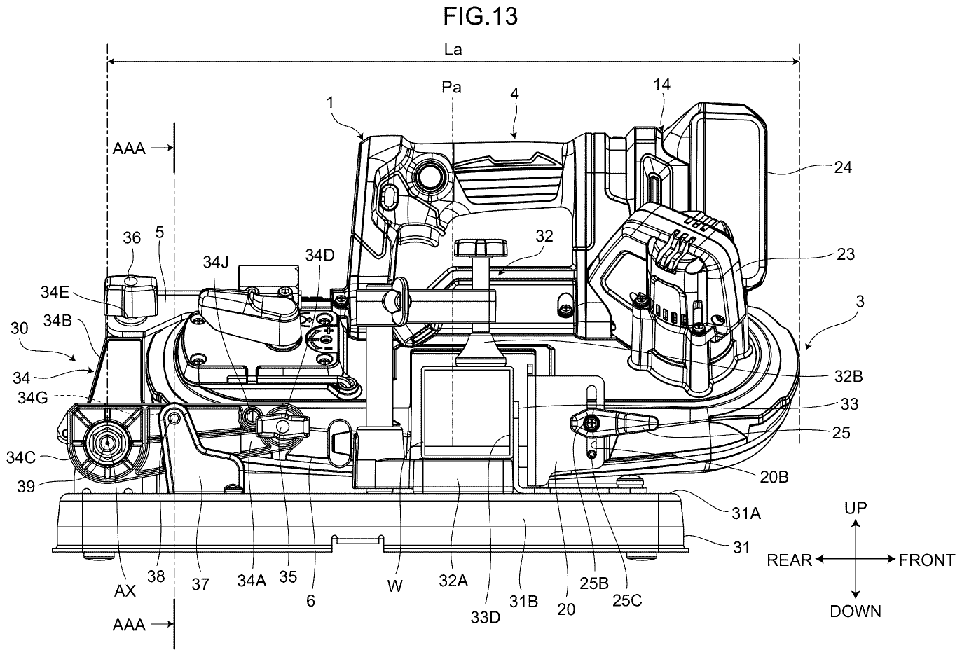

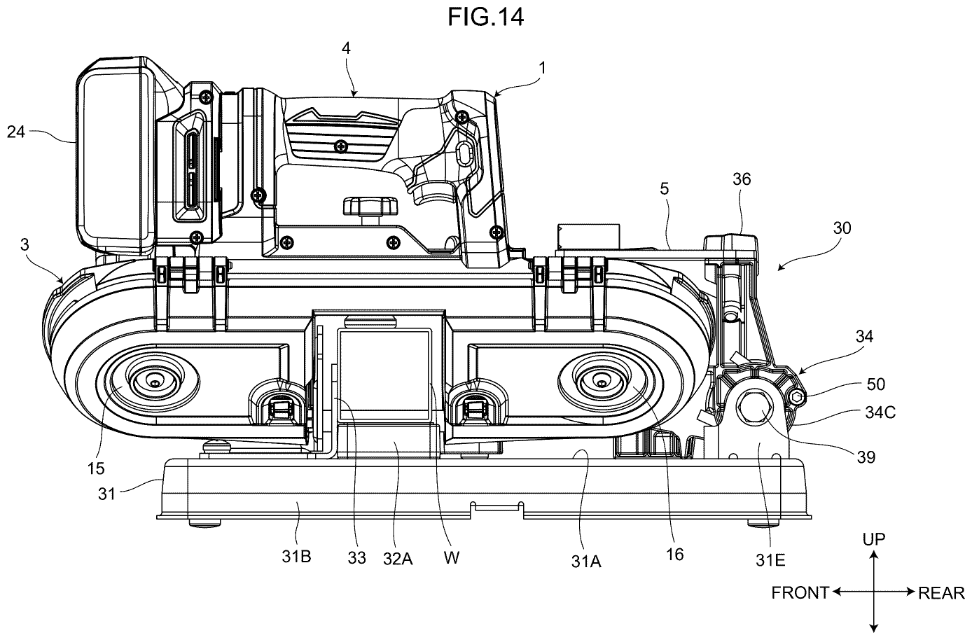

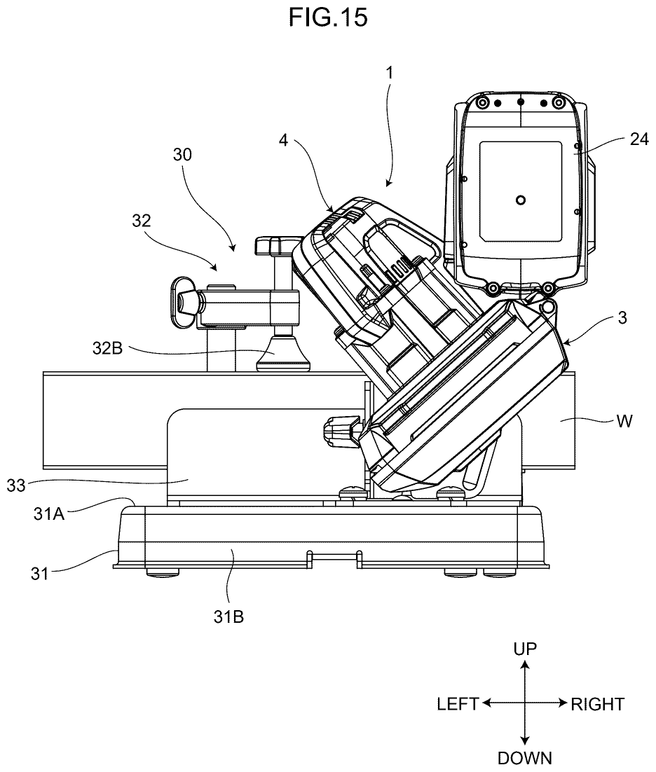

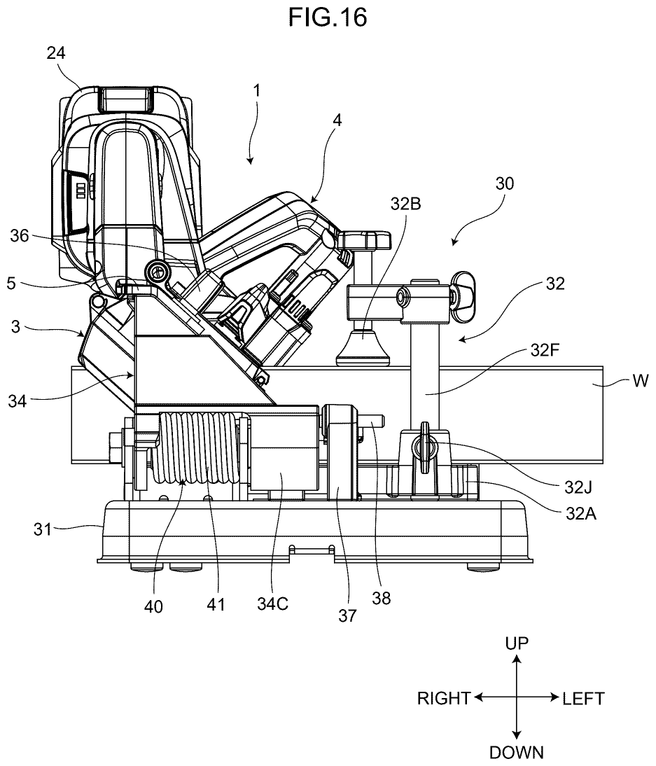

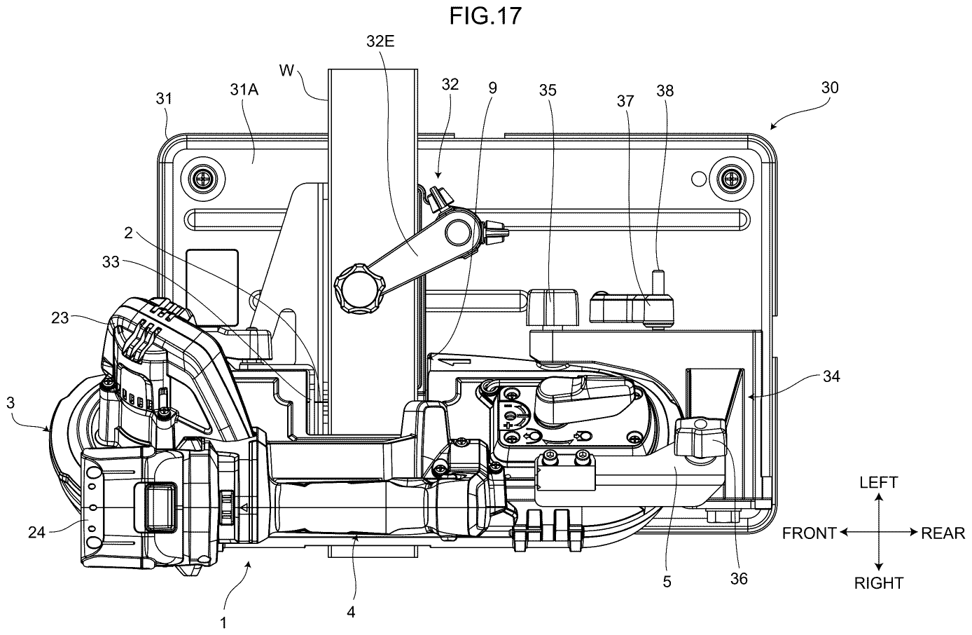

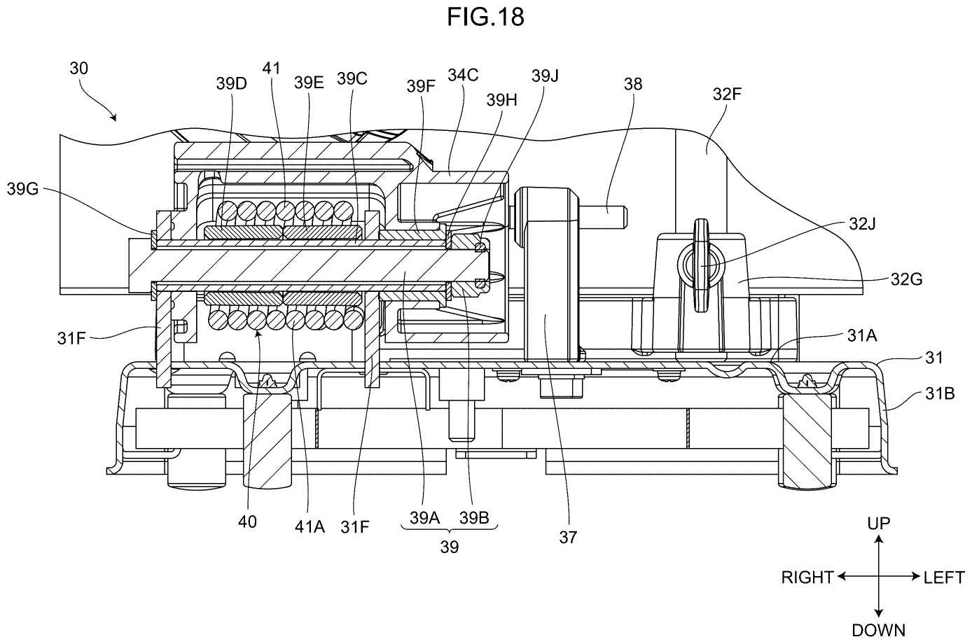

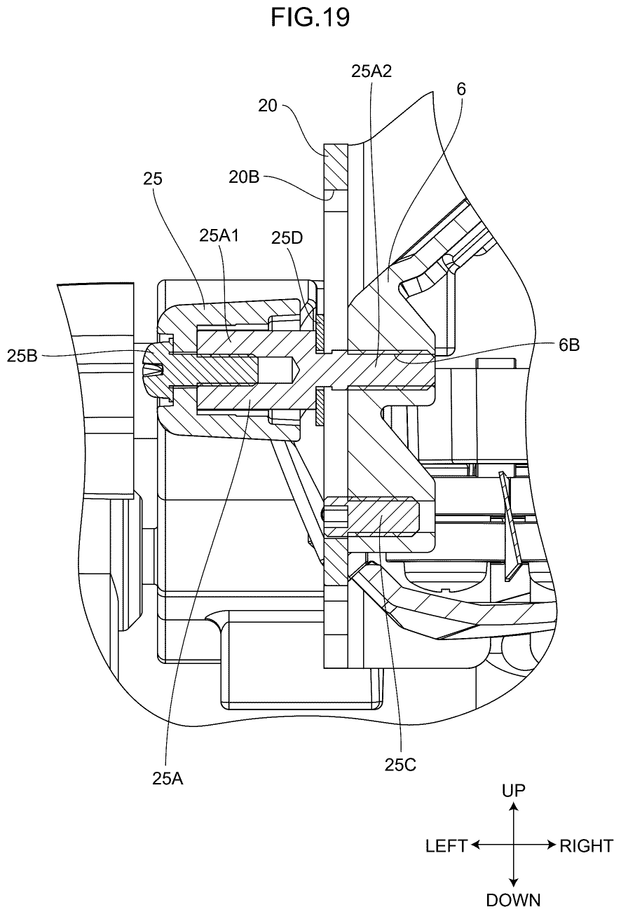

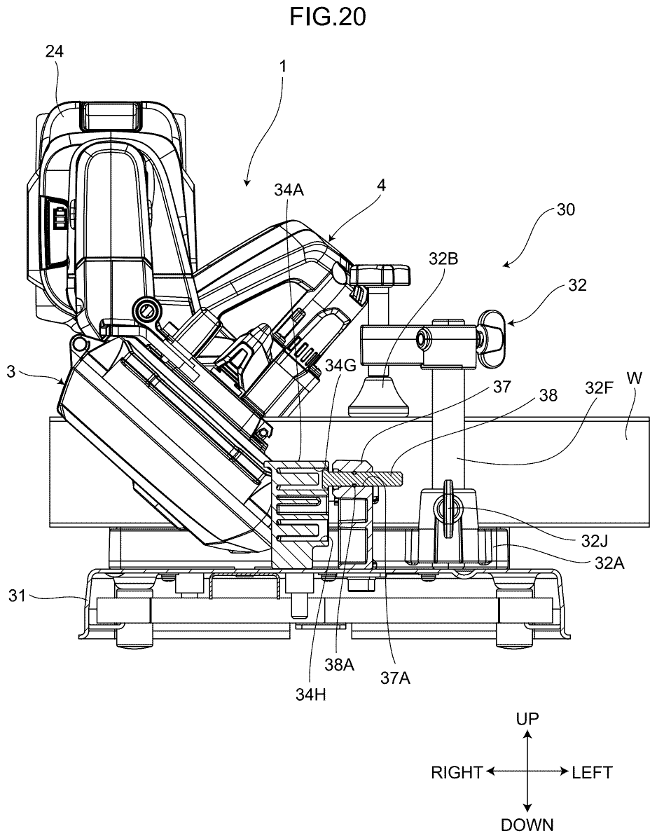

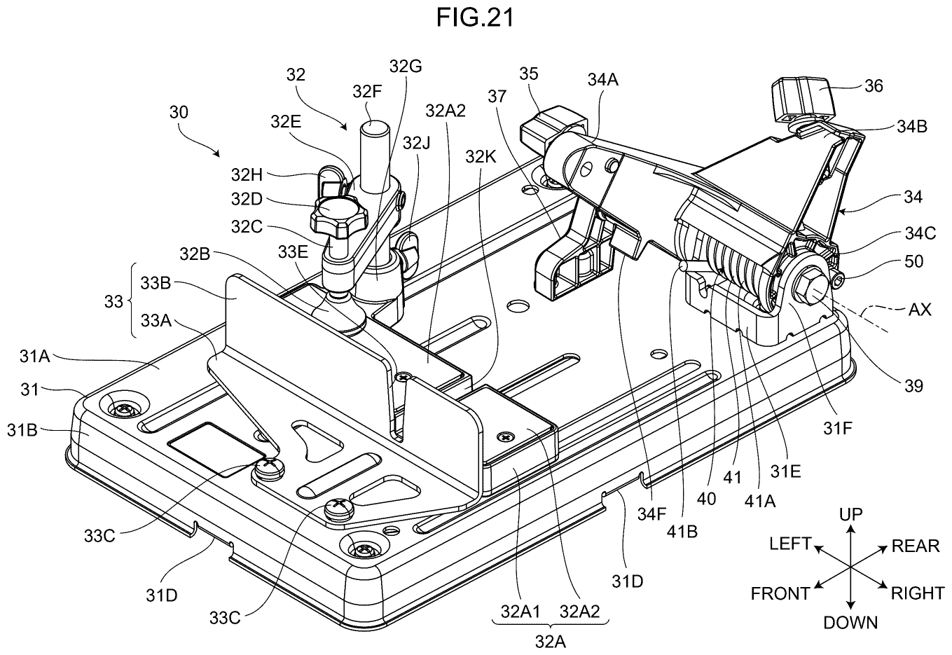

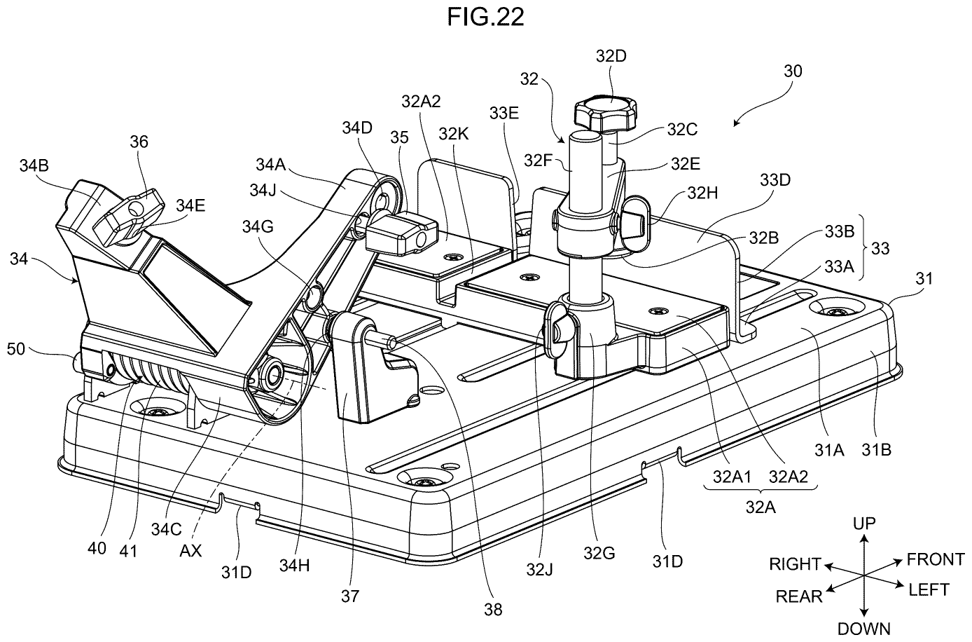

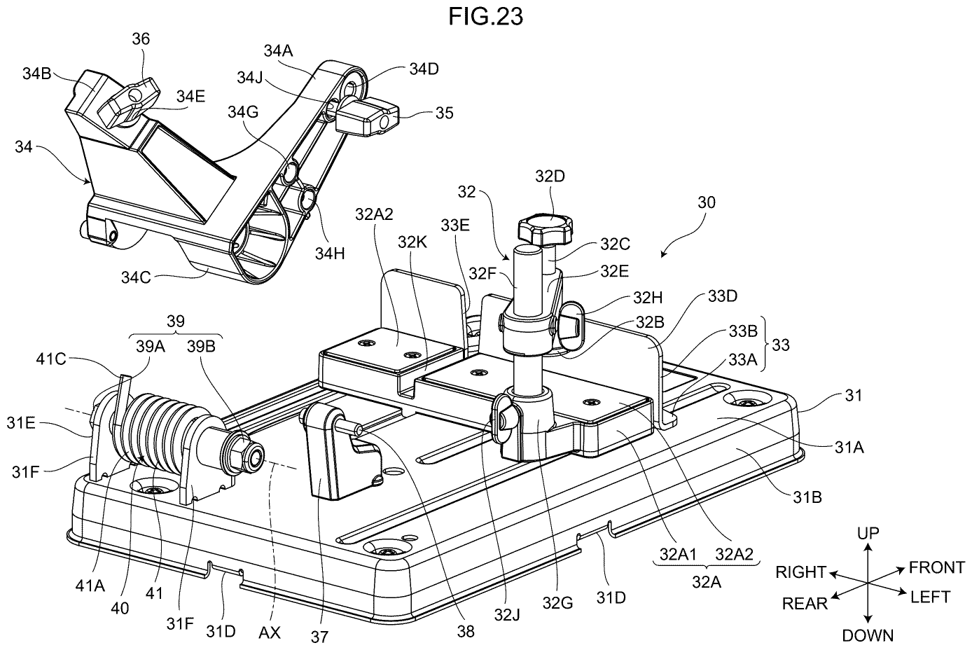

FIG. 5 is a perspective view from the front-upper right side, illustrating the stand 30, according to the embodiment, to which the bandsaw 1 is attached. FIG. 6 is a perspective view from the rear-upper left side, illustrating the stand 30, according to the embodiment, to which the bandsaw 1 is attached. FIG. 7 is a perspective view from the rear-lower left side, illustrating the stand 30, according to the embodiment, to which the bandsaw 1 is attached. FIG. 8 is a view of the stand 30, according to the embodiment, to which the bandsaw 1 is attached, as viewed from the left side. FIG. 9 is a view of the stand 30, according to the embodiment, to which the bandsaw 1 is attached, as viewed from the right side. FIG. 10 is a view of the stand 30, according to the embodiment, to which the bandsaw 1 is attached, as viewed from the front side. FIG. 11 is a view of the stand 30, according to the embodiment, to which the bandsaw 1 is attached, as viewed from behind. FIG. 12 is a view of the stand 30, according to the embodiment, to which the bandsaw 1 is attached, as viewed from above. FIG. 13 is a view of the stand 30, according to the embodiment, to which the bandsaw 1 is attached, as viewed from the left side. FIG. 14 is a view of the stand 30, according to the embodiment, to which the bandsaw 1 is attached, as viewed from the right side. FIG. 15 is a view of the stand 30, according to the embodiment, to which the bandsaw 1 is attached, as viewed from the front side. FIG. 16 is a view of the stand 30, according to the embodiment, to which the bandsaw 1 is attached, as viewed from behind. FIG. 17 is a view of the stand 30, according to the embodiment, to which the bandsaw 1 is attached, as viewed from above. FIG. 18 is a sectional view illustrating a part of the stand 30 according to the embodiment and corresponding to a sectional view taken along line A-A in FIG. 8. FIG. 19 is a sectional view illustrating a part of the stand 30 according to the embodiment and corresponding to a sectional view taken along line AA-AA in FIG. 8. FIG. 20 is a sectional view illustrating a part of the stand 30 according to the embodiment and corresponding to a sectional view taken along line AAA-AAA in FIG. 13. FIG. 21 is a perspective view from the front-upper right side, illustrating the stand 30 according to the embodiment. FIG. 22 is a perspective view from the rear-upper left side, illustrating the stand 30 according to the embodiment. FIG. 23 is an exploded perspective view from the rear-upper left side, illustrating the stand 30 according to the embodiment.

FIGS. 5, 6, 7, 8, 9, 10, 11, and 12 each illustrate a state in which the attachment arm 34, to which the bandsaw 1 is attached, is positioned at a top dead center. FIGS. 13, 14, 15, 16, and 17 each illustrate a state in which the attachment arm 34, to which the bandsaw 1 is attached, is positioned at the bottom dead center. FIGS. 21, 22, and 23 each illustrate a state in which the attachment arm 34 is positioned at the top dead center.

The stand 30 is a portable bandsaw stand to which the portable bandsaw 1 is attached. The stand 30 supports the bandsaw 1. The bandsaw 1 is attachable to and detachable from the stand 30. The bandsaw 1 is used as a stationary bandsaw, which is a kind of stationary cutting machine, by being attached to the stand 30. The bandsaw 1 is supported by the stand 30 so as to be swingable in the up-down direction. A swing fulcrum AX is defined at a rear portion of the bandsaw 1 with the bandsaw 1 attached to the stand 30. A front portion of the bandsaw 1 swings in the up-down direction.

In an attached state in which the bandsaw 1 is attached to the stand 30, the user of the bandsaw 1 positions on the front side of the stand 30 and carries out work. The attached state refers to a state of using the bandsaw 1 attached to the stand 30. In the attached state, the user positions on the front side of the stand 30 to which the bandsaw 1 is attached, and carries out work while gripping the handle 4 with the right hand.

In the embodiment, as viewed from the user, a near side is defined as the front side and a back side is defined as the rear side according to traditional practice of the stand 30. That is, the front side of the stand 30 is the user side, and the rear side of the stand 30 is the counter-user side. When viewed from the user, the left-hand side of the user is the left side, and the right-hand side of the user is the right side.

The stand 30 includes a base 31, a vise 32, a fence 33, the attachment arm 34, a first fastener 35, a second fastener 36, a support member 37, a lock member 38, and a return device 40.

The base 31 supports the vise 32, the fence 33, the attachment arm 34, and the return device 40. The base 31 supports the workpiece W. The workpiece W is placed on an upper surface of the base 31. The outer shape of the base 31 is rectangular in plan view of the base 31 viewed from above. The outer shape of the base 31 is substantially rectangular parallelepiped. The dimension of the base 31 in the up-down direction is smaller than the dimension of the base 31 in the front-rear direction and the dimension in the left-right direction.

The base 31 is made of metal. The base 31 may be made of steel or aluminum. The base 31 may be made by drawing or casting. In the embodiment, the base 31 is made of a drawn steel plate formed by drawing a steel plate. The base 31 includes an upper plate portion 31A and a side plate portion 31B that protrudes downward from a peripheral edge of the upper plate portion 31A. The outer shape of the upper plate portion 31A is rectangular. The side plate portion 31B has a rectangular annular shape. As illustrated in FIG. 7, a recess 31C is provided inside the side plate portion 31B. A spare blade 2 is stored in the recess 31C. The recess 31C functions as an accommodation portion (accommodation space) for accommodating the spare blade 2.

The base 31 includes a plurality of hooks 31D that protrude from the side plate portion 31B toward the center of the recess 31C. The hooks 31D are each formed by bending a cut-out portion obtained by cutting a part of the side plate portion 31B, toward the center side (inner side) of the recess 31C. Four hooks 31D are respectively provided on the four sides of the side plate portion 31B. The spare blade 2 is hung on the hooks 31D while being stored in the recess 31C.

The vise 32 is provided on the upper surface of the base 31. The vise 32 fixes the workpiece W. The vise 32 clamps the workpiece W in the up-down direction. As illustrated in FIGS. 21 and 22, the vise 32 includes a support table 32A, a vise plate 32B, a screw 32C, a knob 32D, a screw support member 32E, a guide rod 32F, a rod support member 32G, a first thumb screw 32H, and a second thumb screw 32J.

The support table 32A is fixed to the upper surface of the base 31. The outer shape of the support table 32A is substantially rectangular parallelepiped. The support table 32A supports the workpiece W from below. The workpiece W is placed on an upper surface of the support table 32A. The support table 32A includes a block portion 32A1 that is made of aluminum and is fixed to the upper surface of the base 31, and a plate portion 32A2 that is made of steel and is fixed to an upper surface of the block portion 32A1. The workpiece W comes into contact with an upper surface of the plate portion 32A2. Since the block portion 32A1 is made of aluminum, the weight of the support table 32A can be made lighter. Since the plate portion 32A2 with which the workpiece W comes into contact is made of steel, wear of the support table 32A is suppressed.

A groove 32K is provided more rightward than the center of the support table 32A in the left-right direction. The groove 32K is long in the front-rear direction. When the bandsaw 1 is positioned at the bottom dead center, the blade 2 is inserted into the groove 32K.

The vise plate 32B faces the support table 32A. The vise plate 32B is disposed above the support table 32A. The vise plate 32B is movable in the up-down direction. The screw 32C is fixed to an upper portion of the vise plate 32B. The central axis of the screw 32C is parallel to the up-down axis. The knob 32D is fixed to an upper end of the screw 32C. The screw support member 32E rotatably supports the screw 32C. The screw 32C rotates, whereby the vise plate 32B moves in the up-down direction. The guide rod 32F guides the screw support member 32E in the up-down direction. The central axis of the guide rod 32F is parallel to the up-down axis. The screw support member 32E is movable in the up-down direction with respect to the guide rod 32F. A lower end of the guide rod 32F is rotatably supported by the rod support member 32G. In the embodiment, the rod support member 32G is integrated with the block portion 32A1 of the support table 32A. The rod support member 32G and the block portion 32A1 are a single member. The guide rod 32F is supported by the rod support member 32G to be rotatable about the central axis of the guide rod 32F. The first thumb screw 32H is rotated in one direction, thereby fixing the screw support member 32E and the guide rod 32F. The first thumb screw 32H is rotated in the other direction, thereby releasing the fixation between the screw support member 32E and the guide rod 32F. The second thumb screw 32J is rotated in one direction, thereby fixing the guide rod 32F and the rod support member 32G. The second thumb screw 32J is rotated in the other direction, thereby releasing the fixation between the guide rod 32F and the rod support member 32G.

When fixing the workpiece W with the vise 32, the workpiece W is placed on the upper surface of the support table 32A, and the screw 32C is subsequently rotated such that the vise plate 32B moves downward. The user pinches and rotates the knob 32D with his/her fingers, whereby the vise plate 32B can move downward. The vise plate 32B moves downward in a state in which the workpiece W is disposed between the support table 32A and the vise plate 32B, whereby the workpiece W is clamped between the support table 32A and the vise plate 32B. This allows the workpiece W to be fixed to the vise 32.

The user releases the fixation of the screw support member 32E by the first thumb screw 32H and moves the screw support member 32E in the up-down direction, whereby the user can adjust the position of the vise plate 32B in the up-down direction with respect to the support table 32A. In addition, the fixation of the screw support member 32E by the first thumb screw 32H is released and the screw support member 32E is rotated in the horizontal direction, whereby the position of the vise plate 32B can be adjusted in the horizontal direction (left-right direction) with respect to the support table 32A. The user releases the fixation of the guide rod 32F by the second thumb screw 32J and rotates the guide rod 32F, whereby the user can adjust the position of the vise plate 32B in the horizontal direction (left-right direction) with respect to the support table 32A.

The fence 33 is provided on the upper surface of the base 31. The fence 33 supports the workpiece W placed on the support table 32A from the side. In the embodiment, the fence 33 supports the workpiece W placed on the support table 32A from the front side (user side). The fence 33 has a plate shape. The fence 33 is formed by bending a plate made of metal. The fence 33 includes a fixing portion 33A that is fixed to the base 31, and a facing portion 33B facing the workpiece W. The fixing portion 33A is fixed to the upper plate portion 31A by screws 33C. The facing portion 33B has an abutment surface 33D facing the workpiece W. The workpiece W is fixed to the vise 32 while being in contact with at least a part of the abutment surface 33D. The abutment surface 33D is orthogonal to the front-rear axis. The abutment surface 33D faces the rear side (counter-user side). The vise 32 is disposed rearward (counter-user side) of the abutment surface 33D.

A groove 33E is provided more rightward than the center of the fence 33 in the left-right direction. The groove 33E is long in the up-down direction. When the bandsaw 1 is positioned at the bottom dead center, the blade 2 is inserted into the groove 33E. The blade 2 is movable inside the groove 33E in the up-down direction.

The attachment arm 34 supports the bandsaw 1. The bandsaw 1 is attached to the attachment arm 34. The attachment arm 34 is swingably supported by the base 31. The attachment arm 34 is swingable about the swing fulcrum AX. An axis of the swing fulcrum AX extends in the left-right direction. The axis of the swing fulcrum AX is parallel to the left-right axis. The swing fulcrum AX is disposed rearward (counter-user side) of the drive wheel 15.

As illustrated in FIG. 23, in the embodiment, the base 31 includes a bracket 31E. The bracket 31E is fixed to the upper plate portion 31A. The attachment arm 34 is swingably supported about the swing fulcrum AX by the bracket 31E of the base 31. The bracket 31E is disposed on a rear-right portion of the upper surface of the upper plate portion 31A. The bracket 31E includes a pair of support portions 31F that are spaced apart from each other in the left-right direction. A swing support shaft 39 of the attachment arm 34 is supported by the support portions 31F of the bracket 31E. As illustrated in FIGS. 18 and 23, the swing support shaft 39 includes a bolt 39A and a nut 39B that is coupled to the bolt 39A. The central axis of the swing support shaft 39 and the axis of the swing fulcrum AX coincide with each other. The attachment arm 34 is swingably supported by the swing support shaft 39.

The attachment arm 34 includes a cylindrical portion 34C, a first arm portion 34A, and a second arm portion 34B. The cylindrical portion 34C is disposed around the swing fulcrum AX. The cylindrical portion 34C is disposed around the swing support shaft 39. The cylindrical portion 34C pivots about the swing fulcrum AX. The first arm portion 34A extends forward (user side) from the cylindrical portion 34C. The second arm portion 34B extends upward from the cylindrical portion 34C. Each of the first arm portion 34A and the second arm portion 34B turns around the swing fulcrum AX. Each of the first arm portion 34A and the second arm portion 34B is fixed to the bandsaw 1.

The attachment arm 34 is made of a die-cast alloy. In the embodiment, the attachment arm 34 is formed by die-casting an aluminum alloy. That the attachment arm 34 may be formed by die-casting a magnesium alloy.

The first fastener 35 fixes the first arm portion 34A to the bandsaw 1. The second fastener 36 fixes the second arm portion 34B to the bandsaw 1. The first arm portion 34A is fixed to at least a part of the bandsaw 1 by the first fastener 35. The second arm portion 34B is fixed to at least a part of the bandsaw 1 by the second fastener 36.

Each of the first fastener 35 and the second fastener 36 is a thumb screw. The thumb screw is a screw that can be tightened or loosed by the user with his/her fingers. As illustrated in FIGS. 8 and 22, an opening 34D into which a threaded portion of the first fastener 35 is inserted is provided in the first arm portion 34A. A threaded hole 34E into which a threaded portion of the second fastener 36 is inserted is provided in the second arm portion 34B. As illustrated in FIG. 1, a threaded hole 6A into which the threaded portion of the first fastener 35 is inserted is provided at a rear-lower-left portion of the base housing 6 of the bandsaw 1. An opening 5A into which the threaded portion of the second fastener 36 is inserted is provided at a rear portion of the plate 5 of the bandsaw 1.

The first fastener 35 is rotated with the threaded portion of the first fastener 35 inserted into the threaded hole 6A through the opening 34D, whereby the threaded portion of the first fastener 35 is coupled to the threaded hole 6A, and the first arm portion 34A is fixed to the base housing 6. The second fastener 36 is rotated with the threaded portion of the second fastener 36 inserted into the threaded hole 34E through the opening 5A, whereby the threaded portion of the second fastener 36 is coupled to the threaded hole 34E, and the second arm portion 34B is fixed to the plate 5. The user can fix the first arm portion 34A to the bandsaw 1 by pinching and rotating the first fastener 35 with his/her fingers without using a tool. The user can fix the second arm portion 34B to the bandsaw 1 by pinching and rotating the second fastener 36 with his/her fingers without using a tool.

The attachment arm 34 swings about the swing fulcrum AX within a defined movable area. The attachment arm 34 swings between the top dead center and the bottom dead center. The top dead center refers to the highest position in the movable area. The bottom dead center refers to the lowest position of the movable area.

When the attachment arm 34 swings about the swing fulcrum AX, a tip of the first arm portion 34A substantially moves in the up-down direction. When the attachment arm 34 is positioned at the top dead center, the tip of the first arm portion 34A is positioned at the uppermost position in a movable area of the tip of the first arm portion 34A. When the attachment arm 34 is positioned at the bottom dead center, the tip of the first arm portion 34A is positioned at the lowermost position in the movable area of the tip of the first arm portion 34A.

When the attachment arm 34 swings about the swing fulcrum AX, a tip of the second arm portion 34B substantially moves in the front-rear direction. When the attachment arm 34 is positioned at the top dead center, the tip of the second arm portion 34B is positioned at the rearmost position in a movable area of the tip of the second arm portion 34B. When the attachment arm 34 is positioned at the bottom dead center, the tip of the second arm portion 34BA is positioned at the frontmost position in the movable area of the tip of the second arm portion 34B.

When the attachment arm 34 swings about the swing fulcrum AX, the bandsaw 1 attached to the attachment arm 34 swings in a manner to turn around the swing fulcrum AX. The bandsaw 1 is attached to the attachment arm 34 such that the driven wheel 16 is disposed rearward (counter-user side) of the drive wheel 15. The swing fulcrum AX is disposed rearward (counter-user side) of the drive wheel 15. In the embodiment, the swing fulcrum AX is disposed rearward (counter-user side) of the driven wheel 16. A front end (user-side end) of the bandsaw 1 moves substantially in the up-down direction. When the attachment arm 34 is positioned at the top dead center, the front end of the bandsaw 1 is positioned at the uppermost position in a movable area of the front end of the bandsaw 1. When the attachment arm 34 is positioned at the bottom dead center, the front end of the bandsaw 1 is positioned at the lowermost position in the movable area of the front end of the bandsaw 1. When the attachment arm 34 is positioned at the top dead center of the attachment arm 34, the bandsaw 1 is positioned at the top dead center of the bandsaw 1. When the attachment arm 34 is positioned at the bottom dead center of the attachment arm 34, the bandsaw 1 is positioned at the bottom dead center of the bandsaw 1.

As illustrated in FIGS. 9 and 21, a screw 50 is fixed to the cylindrical portion 34C of the attachment arm 34. The screw 50 is inserted from the right side of the cylindrical portion 34C into a threaded hole provided in the cylindrical portion 34C. The head of the screw 50 protrudes rightward from a right surface of the cylindrical portion 34C. The head of the screw 50 is disposed rearward of the bracket 31E. The screw 50 defines a swing range of the attachment arm 34. The screw 50 defines the top dead center of the attachment arm 34. The attachment arm 34 moves (swings) upward from the bottom dead center and then the head of the screw 50 comes into contact with a rear surface of the bracket 31E, whereby upward movement of the attachment arm 34 is restricted. The position of the attachment arm 34 where the head of the screw 50 and the rear surface of the bracket 31E are in contact with each other serves as the top dead center of the attachment arm 34.

As illustrated in FIG. 21, a projection 34F is provided on a lower surface of the first arm portion 34A. The projection 34F protrudes downward from the lower surface of the first arm portion 34A. The projection 34F is disposed upward of the upper plate portion 31A. The projection 34F defines the swing range of the attachment arm 34. The projection 34F defines the bottom dead center of the attachment arm 34. The attachment arm 34 moves (swings) downward from the top dead center and then the projection 34F comes into contact with the upper surface of the base 31, whereby downward movement of the attachment arm 34 is restricted. The position of the attachment arm 34 where the projection 34F and the upper surface of the base 31 are in contact with each other serves as the bottom dead center of the attachment arm 34.

The return device 40 automatically returns the attachment arm 34 to the top dead center. In the embodiment, the return device 40 includes a spring 41 interposed between the base 31 and the attachment arm 34. The attachment arm 34 is returned to the top dead center by urging force of the spring 41. The attachment arm 34 is held (maintained) at the top dead center by the urging force of the spring 41. In the embodiment, the spring 41 is a torsion spring.

As illustrated in FIGS. 21 and 23, the spring 41 includes a coil portion 41A, an arm portion 41B that protrudes from one end of the coil portion 41A, and an arm portion 41C that protrudes from the other end of the coil portion 41A. The swing support shaft 39 of the attachment arm 34 is inserted into the inside of the coil portion 41A. One of the arm portions of the spring 41, which is the arm portion 41B, is in contact with the bracket 31E of the base 31. The one of the arm portions of the spring 41, which is the arm portion 41B, presses the bracket 31E of the base 31 from above. The other of the arm portions of the spring 41, which is the arm portion 41C, is in contact with the cylindrical portion 34C of the attachment arm 34. The other of the arm portions of the spring 41, which is the arm portion 41C, presses the attachment arm 34 up to the top dead center.

As illustrated in FIG. 18, the spring 41 is disposed inside the cylindrical portion 34C. The swing support shaft 39 is inserted into the inside of the coil portion 41A. The swing support shaft 39 includes the bolt 39A and the nut 39B. The head of the bolt 39A is disposed rightward of the support portions 31F. The nut 39B is disposed leftward of the support portions 31F.

A sleeve 39C is disposed around the shaft portion of the bolt 39A. The shaft portion of the bolt 39A is disposed inside the sleeve 39C. The sleeve 39C is supported by the support portions 31F. The support portions 31F support the shaft portion of the bolt 39A via the sleeve 39C.

A first sleeve 39D and a second sleeve 39E are arranged around the sleeve 39C. The first sleeve 39D is disposed rightward of the second sleeve 39E. The first sleeve 39D and the second sleeve 39E are arranged between the support portion 31F on the left side and the support portion 31F on the right side in the left-right direction. The outer shape and dimensions of the first sleeve 39D are substantially the same as the outer shape and dimensions of the second sleeve 39E. The coil portion 41A is disposed around the first sleeve 39D and the second sleeve 39E.

A sleeve 39F is disposed between the nut 39B and the support portion 31F on the left side. The sleeve 39F is disposed around the sleeve 39C. A right portion of the sleeve 39C and the sleeve 39F are connected to the cylindrical portion 34C.

A washer 39G is disposed between the head of the bolt 39A and the support portion 31F on the right side. A washer 39H is disposed between the sleeve 39F and the nut 39B. Used as the nut 39B is an anti-loosening nut (nylon nut: JIS B1199-1) in which an O-ring 39J made of polyamide is provided, as a resin member, in a circular annular groove at the mouth of its threaded hole, for example.

The support member 37 is fixed to the upper surface of the base 31. The support member 37 protrudes upward from the upper surface of the base 31. The support member 37 is disposed leftward of the attachment arm 34. The support member 37 is disposed at a position facing a left surface of the first arm portion 34A.

The lock member 38 is movably supported by the support member 37. The lock member 38 is a pin-shaped (rod-shaped) member that is long in the left-right direction. As illustrated in FIG. 20, the support member 37 has a support hole 37A in which at least a part of the lock member 38 is disposed. The lock member 38 is movably supported in the left-right direction by the support hole 37A of the support member 37. The lock member 38 moves in the left-right direction at the left side of the first arm portion 34A. The lock member 38 is inserted into at least a part of the first arm portion 34A, thereby fixing the attachment arm 34.

As illustrated in FIG. 20, an O-ring 38A is provided around the lock member 38. The O-ring 38A is disposed in a groove provided in an outer surface of the lock member 38. The O-ring 38A is disposed at a boundary between the outer surface of the lock member 38 and an inner surface of the support hole 37A. The O-ring 38A is in contact with the inner surface of the support hole 37A. The O-ring 38A is in contact with the inner surface of the support hole 37A, whereby unintended movement of the lock member 38 is inhibited. In addition, when the lock member 38 moves, the O-ring 38A moves while coming into contact with the inner surface of the support hole 37A, so that an adequate sense of resistance is obtained as the lock member 38 moves.

As illustrated in FIGS. 20, 22, and 23, the first arm portion 34A has an insertion hole 34G for the bottom dead center and an insertion hole 34H for the top dead center. Each of the insertion hole 34G for the bottom dead center and the insertion hole 34H for the top dead center is provided so as to be recessed rightward from the left surface of the first arm portion 34A. The insertion hole 34G for the bottom dead center is disposed upward of the insertion hole 34H for the top dead center.

The lock member 38 is moved rightward while being supported by the support member 37, thereby being inserted into at least one of the insertion hole 34G for the bottom dead center or the insertion hole 34H for the top dead center. The lock member 38 is inserted into the insertion hole 34G for the bottom dead center, whereby the attachment arm 34 is fixed to the bottom dead center. The lock member 38 is inserted into the insertion hole 34H for the top dead center, whereby the attachment arm 34 is fixed to the top dead center.

The first arm portion 34A includes a storage portion 34J that stores at least a part of the first fastener 35. In the embodiment, the storage portion 34J is a threaded hole into which the threaded portion of the first fastener 35 is inserted. As illustrated in FIG. 22, the storage portion 34J is provided behind the opening 34D. The storage portion 34J is provided adjacent to the opening 34D. The threaded portion of the first fastener 35 is coupled to the threaded hole serving as the storage portion 34J, whereby the first fastener 35 is fixed to the first arm portion 34A. As illustrated in FIG. 22, in a case where the bandsaw 1 is not attached to the stand 30, the threaded portion of the first fastener 35 is coupled to the threaded hole serving as the storage portion 34J, whereby loss of the first fastener 35 is inhibited. In the case where the bandsaw 1 is not attached to the stand 30, the threaded portion of the second fastener 36 is also coupled to the threaded hole 34E of the second arm portion 34B, whereby the second fastener 36 is fixed to the second arm portion 34B, and loss of the second fastener 36 is inhibited.

As described above, the stopper plate 20 is fixed to the base housing 6 by the fixing lever 25. The position of the stopper plate 20 in the up-down direction with respect to the base housing 6 is adjustable. The stopper plate 20 is movable in the up-down direction while the slit 20B is guided by the pivot member 25A and the stopper pin 25C. After the stopper plate 20 is moved in the up-down direction in a state in which the fixation of the stopper plate 20 is released, the fixing lever 25 is turned in the one direction, whereby the stopper plate 20 is fixed at a certain position in the up-down direction. When attaching the bandsaw 1 to the stand 30, the stopper plate 20 is positioned at the uppermost position in a movable area of the stopper plate 20. That is, when attaching the bandsaw 1 to the stand 30, the stopper plate 20 is fixed to the housing 3 such that an amount of downward protrusion from a lower end of the housing 3 becomes the smallest.

As illustrated in FIGS. 1, 8, and 19, the stopper plate 20 is fixed to the base housing 6 by the fixing lever 25. The fixing lever 25 is connected to the left portion of the base housing 6 via the pivot member 25A. The fixing lever 25 and the pivot member 25A are fixed by the screw 25B. The pivot member 25A includes a fixing portion 25A1 that is fixed to the fixing lever 25 by the screw 25B, and a threaded portion 25A2 that is disposed rightward of the fixing portion 25A1. The threaded portion 25A2 is inserted into a threaded hole 6B provided in the base housing 6. The diameter of the fixing portion 25A1 is larger than the diameter of the threaded portion 25A2. The fixing portion 25A1 is provided leftward of the threaded portion 25A2. A washer 25D is disposed between a right surface of the fixing portion 25A1 and the stopper plate 20. At least a part of the pivot member 25A is inserted into the slit 20B provided in the stopper plate 20 from the left side of the stopper plate 20. The threaded portion 25A2 is inserted into the threaded hole 6B with at least a part of the pivot member 25A inserted into the slit 20B.

The stopper pin 25C is disposed downward of the pivot member 25A. The stopper pin 25C is screwed into and fixed to the base housing 6. At least a part of the stopper pin 25C protrudes leftward from a left surface of the base housing 6. At least a part of the stopper pin 25C is disposed in the slit 20B.

The slit 20B is long in the up-down direction. The fixing lever 25 is turned in the one direction and the pivot member 25A is rotated in the one direction, whereby the pivot member 25A moves rightward. The pivot member 25A is moved rightward, whereby the stopper plate 20 is sandwiched and secured between a washer 25D and the base housing 6, and the stopper plate 20 is fixed to the base housing 6. The fixing lever 25 is turned in the other direction and the pivot member 25A is rotated in the other direction, whereby the pivot member 25A moves leftward. The pivot member 25A is moved leftward, whereby the fixation of the stopper plate 20 is released.

The position of the stopper plate 20 in the up-down direction with respect to the base housing 6 is adjustable. The stopper plate 20 is movable in the up-down direction while the slit 20B is guided by the pivot member 25A and the stopper pin 25C. After the stopper plate 20 is moved in the up-down direction in a state in which the fixation of the stopper plate 20 is released, the fixing lever 25 is turned in the one direction, whereby the stopper plate 20 is fixed at a certain position in the up-down direction.

The stopper pin 25C defines the movable range of the stopper plate 20. When being disposed at the uppermost position in the movable range of the stopper plate 20, the stopper pin 25C comes into contact with a lower end of the slit 20B.

As illustrated in FIGS. 1 and 17, in the left-right direction parallel to the axis of the swing fulcrum AX, the position of a cutting portion of the blade 2 with respect to the handle 4 in the attached state in which the band saw 1 is attached to the stand 1, is the same as the position of the cutting portion of the blade 2 with respect to the handle 4 in the normal use state in which the bandsaw 1 is normally used. The attached state refers to the state of using the bandsaw 1 attached to the stand 30. The normal use state refers to the state of using the bandsaw 1 removed from the stand 30 (i.e., using the bandsaw without being attached to the stand). The cutting portion of the blade 2 refers to a part, of the blade 2, disposed in the opening 9. The workpiece W is cut by the blade 2 disposed in the opening 9. As described above, also in the normal use state, the user positions (stands) on the front side of the bandsaw 1 and carries out work while gripping the handle 4. In the embodiment, the cutting portion of the blade 2 is disposed leftward of the handle 4 in both the attached state and the normal use state.

As illustrated in FIG. 13, in the front-rear direction, the battery pack 24 mounted on the battery mounting portion 14 is disposed forward (user side) of a position Pa that is half a distance La from the swing fulcrum AX to a front end (user-side end) of the housing 3.

### Method of Using Bandsaw

Next, a method of using the bandsaw 1 will be described. In the normal use state, the user positions (stands) on the front side of the bandsaw 1 and grips the handle 4 with the right hand. When the user positions (stands) on the front side of the bandsaw 1 and grips the handle 4 with the right hand, the cutting portion of the blade 2 is disposed leftward of the handle 4. The user can see the cutting portion of the blade 2 while gripping the handle 4 with the right hand.

When cutting the workpiece W in the normal use state, the user pulls the main switch 21 with a finger of the right hand gripping the handle 4. The main switch 21 is pulled, whereby the motor 13 is driven to rotate the blade 2. In the state in which the blade 2 is rotating, the user presses the blade 2 disposed in the opening 9 against the workpiece W, whereby the workpiece W is cut. When cutting the workpiece W, the workpiece W is supported by the stopper plate 20 from the front side.

The stopper plate 20 is not used when using the stand. When attaching the bandsaw 1 to the stand 30, the user operates the fixing lever 25 so as to release the fixation of the stopper plate 20, and subsequently adjusts the position of the stopper plate 20 such that the amount of downward protrusion of the stopper plate 20 from the lower end of the housing 3 becomes the smallest. After adjusting the position of the stopper plate 20 such that the amount of downward protrusion of the stopper plate 20 from the lower end of the housing 3 becomes the smallest, the user operates the fixing lever 25 such that the stopper plate 20 is fixed.

When using the stand, the bandsaw 1 is attached to the attachment arm 34. The user fixes the base housing 6 of the bandsaw 1 and the first arm portion 34A with the first fastener 35, and fixes the plate 5 of the bandsaw 1 and the second arm portion 34B with the second fastener 36. The user places the workpiece W on the support table 32A such that the workpiece W is in contact with the abutment surface 33D of the fence 33, and subsequently fixes the workpiece W with the vise 32. The workpiece W is supported by the fence 33 from the front side.

After attaching the bandsaw 1 to the attachment arm 34 and fixing the workpiece W with the vise 32, the user positions on the front side of the bandsaw 1 and grips the handle 4 with the right hand. When the user positions on the front side of the bandsaw 1 and grips the handle 4 with the right hand, the cutting portion of the blade 2 is disposed leftward of the handle 4. The user can see the cutting portion of the blade 2 while gripping the handle 4 with the right hand.

When cutting the workpiece W using the stand, the user pulls the main switch 21 with a finger of the right hand gripping the handle. The main switch 21 is pulled, whereby the motor 13 is driven to rotate the blade 2. In the state in which the blade 2 is rotating, the user moves the handle 4 downward such that the attachment arm 34 moves to the bottom dead center. The handle 4 moves downward, whereby the blade 2 disposed in the opening 9 approaches the workpiece W. The blade 2 disposed in the opening 9 is pressed against the workpiece W, whereby the workpiece W is cut. When cutting the workpiece W, the workpiece W is supported by the fence 33 from the front side.

The battery pack 24 is disposed forward (user side) of the position Pa. Hence, when the bandsaw 1 is moved to the bottom dead center, the weight of the battery pack 24 facilitates the movement of the bandsaw 1 to the bottom dead center.

After the bandsaw 1 moves to the bottom dead center and the workpiece W is cut by the blade 2, the user releases the operation of the main switch 21 to stop the motor 13. After the motor 13 is stopped, the user removes the hand from the bandsaw 1 or loosens the downward force pressing against the bandsaw 1, whereby the attachment arm 34 to which the bandsaw 1 is attached is automatically returned to the top dead center by the return device 40.

For example, when replacing the blade 2 with new one with the bandsaw 1 attached to the attachment arm 34, the user inserts the lock member 38 into the insertion hole 34H for the top dead center. The lock member 38 is inserted into the insertion hole 34H for the top dead center, whereby the position of the bandsaw 1 is fixed at the top dead center. The user can, for example, replace the blade 2 in the state in which the position of the bandsaw 1 is fixed at the top dead center.

For example, when transporting or storing the stand 30, the user inserts the lock member 38 into the insertion hole 34G for the bottom dead center. The lock member 38 is inserted into the insertion hole 34G for the bottom dead center, whereby the position of the stand 30 is fixed at the bottom dead center. The user can, for example, transport or store the stand 30 with the stand 30 made compact.

### Effects

As described above, in the embodiment, the stand 30 to which the bandsaw 1 is attached includes the base 31, the attachment arm 34 that is swingably supported about the swing fulcrum AX by the base 31 and to which the bandsaw 1 is attached, and the return device 40 configured to automatically return the attachment arm 34 to the top dead center.

With the above configuration, when the bandsaw 1 is moved to the top dead center, it is not necessary for the user of the bandsaw 1 to lift the bandsaw 1 by himself/herself. Hence, a burden on the user is reduced. In addition, since it is not necessary for the user to lift the bandsaw 1 by himself/herself, the user can quickly shift to other work. Hence, deterioration of work efficiency is inhibited, and an increase in work time is inhibited.

In the embodiment, the return device 40 includes the spring 41 interposed between the base 31 and the attachment arm 34. The position of the attachment arm 34 is held at the top dead center by the urging force of the spring 41.

With the above configuration, by the urging force of the spring 41, the attachment arm 34 is automatically returned to the top dead center, and the position of the attachment arm 34 is reasonably held at the top dead center. The position of the bandsaw 1 is held at the top dead center, for example, without using a lock mechanism.

In the embodiment, the spring 41 is a torsion spring. The swing support shaft 39 of the attachment arm 34 is inserted into the coil portion 41A of the spring 41. One of the arm portions of the spring 41, which is the arm portion 41B, presses the base 31, and the other of the arm portions of the spring 41, which is the arm portion 41C, presses the attachment arm 34 up to the top dead center.

With the above configuration, assemblability during manufacture of the stand 30 is enhanced. In addition, performance when the bandsaw 1 is attached to the stand 30 is also enhanced.

In the embodiment, the bandsaw 1 includes the drive wheel 15 that is rotated by the motor 13, the driven wheel 16, and the blade 2 that is stretched between the drive wheel 15 and the driven wheel 16. The driven wheel 16 is disposed rearward (counter-user side) of the drive wheel 15, and the swing fulcrum AX is disposed rearward (counter-user side) of the drive wheel 15.

With the above configuration, the drive wheel 15 is disposed on the front side (user side) in both the attached state and the normal use state. The user can carry out work with the same operation in both the attached state and the normal use state. The attached state refers to the state of using the bandsaw 1 attached to the stand 30. The normal use refers to the state of using the bandsaw 1 removed from the stand 30 (i.e., using the bandsaw without being attached to the stand).

In the embodiment, the bandsaw 1 includes the housing 3 that accommodates the drive wheel 15 and the driven wheel 16, and the handle 4 that is fixed to the housing 3. In the left-right direction parallel to the axis of the swing fulcrum AX, the position of the cutting portion of the blade 2 with respect to the handle 4 in an attached state in which the bandsaw 1 is attached to the stand 30 is the same as the position of the cutting portion of the blade 2 with respect to the handle 4 in a normal use state in which the bandsaw 1 is normally used.

With the above configuration, the user can carry out work with the same operation in both the attached state and the normal use state.

In the embodiment, the cutting portions of the blade 2 are disposed leftward of the handle 4 in both the attached state and the normal use state.

With the above configuration, when the user grips the handle 4 with the right hand, the user can easily see the cutting portion of the blade 2, so that the deterioration of performance is inhibited.

In the embodiment, the attachment arm 34 includes the cylindrical portion 34C that is disposed around the swing fulcrum AX, the first arm portion 34A that extends from the cylindrical portion 34C to the user side, and the second arm portion 34B that extends upward from the cylindrical portion 34C. The stand 30 includes the first fastener 35 for fixing the first arm portion 34A to the bandsaw 1, and the second fastener 36 for fixing the second arm portion 34B to the bandsaw 1.

With the above configuration, the bandsaw 1 is stably fixed to the stand 30 by the first fastener 35 and the second fastener 36 that are spaced apart from each other.

In the embodiment, at least one of the first fastener 35 or the second fastener 36 is a thumb screw.

With the above configuration, the user can attach and detach the bandsaw 1 to and from the stand 30 without using a tool. The thumb screw is a screw capable of being tightened by the user with his/her fingers. In the embodiment, both the first fastener 35 and the second fastener 36 are thumb screws.

In the embodiment, the stand 30 includes: the vise 32 that is provided on the base 31 and fixes the workpiece W; and the fence 33 that is provided on the base 31 and supports the workpiece W. The abutment surface 33D, of the fence 33, facing the workpiece W faces the rear side (counter-user side), and the vise 32 is disposed rearward (counter-user side) of the abutment surface 33D.

With the above configuration, when cutting the workpiece W with the blade 2, if the workpiece W moves to the front side (user side) due to force of the blade 2 transmitted in the direction of the user, the workpiece W positioned against the fence 33 can be appropriately supported by the abutment surface 33D, of the fence 33, facing the rear side (counter-user side). The workpiece W can be appropriately fixed by the vise 32 disposed rearward (counter-user side) of the abutment surface 33D of the fence 33.

In the embodiment, the stand 30 to which the bandsaw 1 is attached includes: the base 31; and the attachment arm 34 that is swingably supported about the swing fulcrum AX by the base 31 and to which the bandsaw 1 is attached. The bandsaw 1 includes the drive wheel 15 that is rotated by the motor 13, the driven wheel 16, the blade 2 that is stretched between the drive wheel 15 and the driven wheel 16, the housing 3 that accommodates the drive wheel 15 and the driven wheel 16, and the battery mounting portion 14 on which the battery pack 24 is mounted. The driven wheel 16 is disposed rearward (counter-user side) of the drive wheel 15, and the swing fulcrum AX is disposed rearward (counter-user side) of the drive wheel 15. The battery pack 24 mounted on the battery mounting portion 14 is disposed forward (user side) of the position Pa, the position Pa being half the distance La from the swing fulcrum AX to the user-side end of the housing 3.

With the above configuration, when the bandsaw 1 is moved to the bottom dead center, the weight of the battery pack 24 facilitates the movement of the bandsaw 1 to the bottom dead center. Hence, the burden on the user is reduced. In addition, the user can smoothly attach and detach the battery pack 24 to and from the battery mounting portion 14.

In the embodiment, the bandsaw 1 may include the handle 4 that is fixed to the housing 3. The battery mounting portion 14 is provided at the user-side end of the handle 4.

With the above configuration, since the battery pack 24 which is a heavy object, is disposed at the user-side end of the handle 4, an operating feeling when the user moves the bandsaw 1 to the bottom dead center is improved.

In the embodiment, the stand 30 to which the bandsaw 1 is attached includes: the base 31; the attachment arm 34 that includes the cylindrical portion 34C that is swingably supported about the swing fulcrum AX by the base 31 and disposed around the swing fulcrum AX, the first arm portion 34A that extends from the cylindrical portion 34C to the user side, and the second arm portion 34B that extends upward from the cylindrical portion 34C; the first fastener 35 that fixes the first arm portion 34A to the bandsaw 1; and the second fastener 36 that fixes the second arm portion 34B to the bandsaw 1.

With the above configuration, the bandsaw 1 is stably fixed to the stand 30 by the first fastener 35 and the second fastener 36 that are spaced apart from each other.

In the embodiment, the stand 30 includes: the support member 37 that is fixed to the base 31; and the lock member 38 that is movably supported by the support member 37 and fixes the attachment arm 34 by being inserted into at least a part of the first arm portion 34A.

With the above configuration, the position of the attachment arm 34 is fixed by the lock member 38. In addition, an increase in size of a lock mechanism including the support member 37 and the lock member 38 is inhibited.

In the embodiment, the first arm portion 34A has the insertion hole 34G for the bottom dead center. The attachment arm 34 is fixed at the bottom dead center by inserting the lock member 38 into the insertion hole 34G for the bottom dead center.

With the above configuration, the position of the attachment arm 34 is fixed at the bottom dead center by the lock member 38. In addition, an increase in size of the lock mechanism including the support member 37 and the lock member 38 is inhibited.

In the embodiment, the first arm portion 34A has the insertion hole 34G for the bottom dead center and the insertion hole 34H for the top dead center. The attachment arm 34 is fixed at the bottom dead center by inserting the lock member 38 into the insertion hole 34G for the bottom dead center. The attachment arm 34 is fixed at the top dead center by inserting the lock member 38 into the insertion hole 34H for the top dead center.

With the above configuration, the position of the attachment arm 34 is fixed at either the bottom dead center or the top dead center by the lock member 38. The position of the attachment arm 34 is fixed at the top dead center, whereby the user can carry out, for example, replacement of the blade 2 with new one with the bandsaw 1 attached to the stand 30. The position of the attachment arm 34 is fixed at the top dead center, whereby unintended downward movement of the bandsaw 1 is inhibited when replacing the blade 2. In addition, an increase in size of the lock mechanism including the support member 37 and the lock member 38 is inhibited.

In the embodiment, the first arm portion 34A includes the storage portion 34J that stores at least a part of the first fastener 35.

With the above configuration, a dead space of the first arm portion 34A is effectively utilized.

In the embodiment, the outer shape of the base 31 is rectangular in plan view.

With the above configuration, an increase in size of the stand 30 is inhibited. The user can store the stand 30, for example, in a narrow space.

In the embodiment, the base 31 is made of a drawn steel plate. The attachment arm 34 is made of a die-cast alloy.

With the above configuration, both lightweight and high strength of stand 30 can be achieved.

### Second Embodiment

A second embodiment will be described. In the following description, the same or equivalent components as those of the above-described embodiment are denoted by the same reference signs, and the description of the components is simplified or omitted.

### Bandsaw

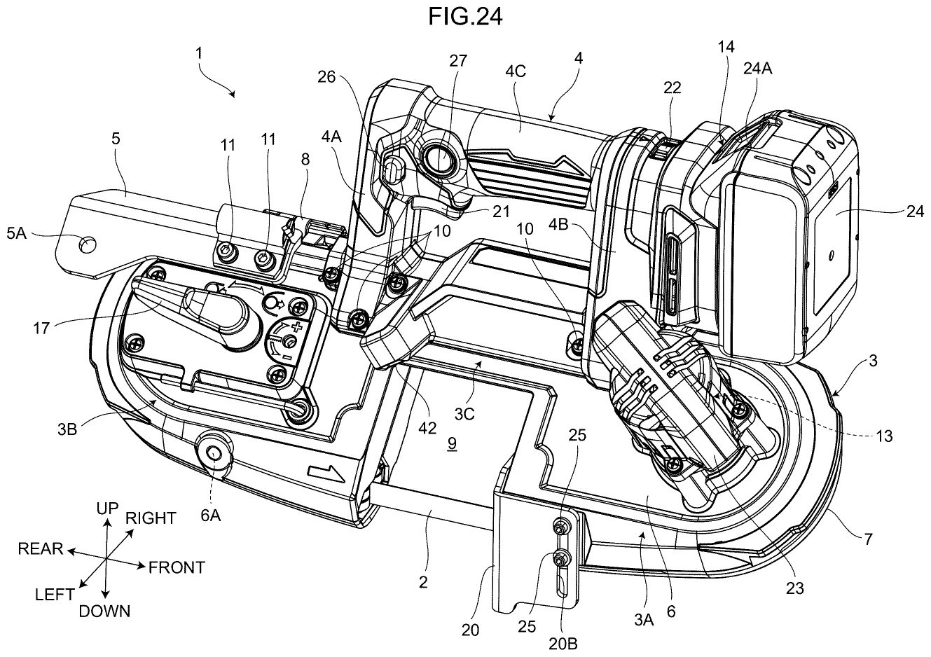

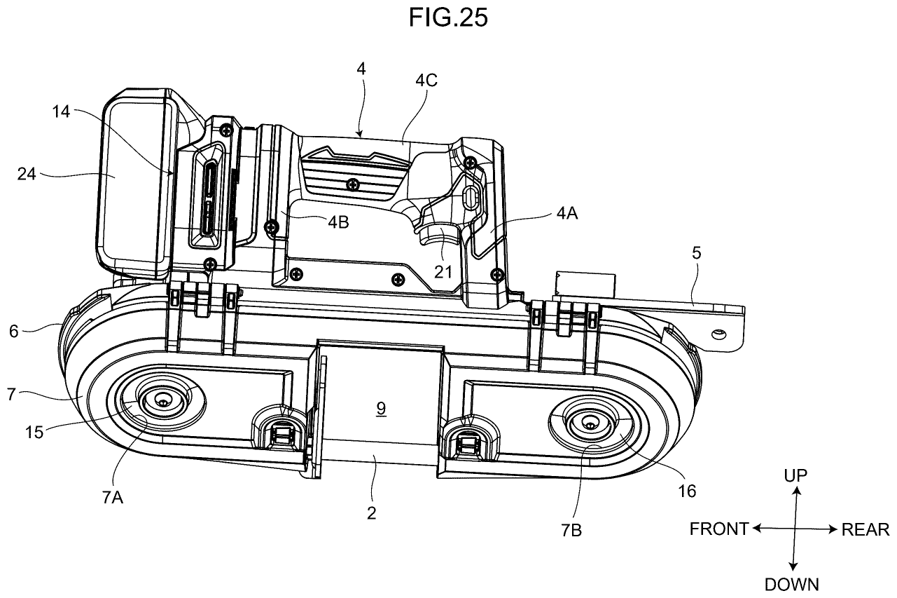

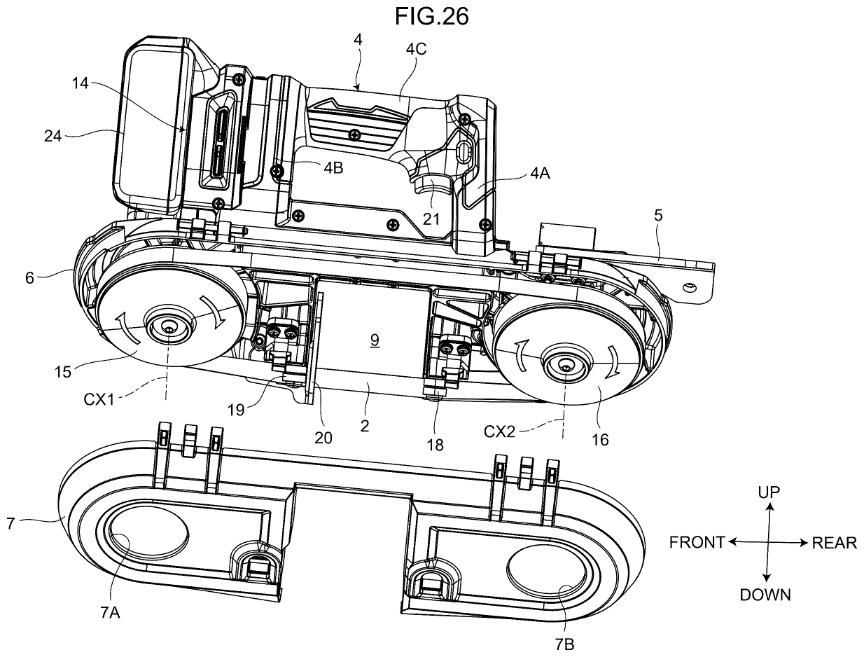

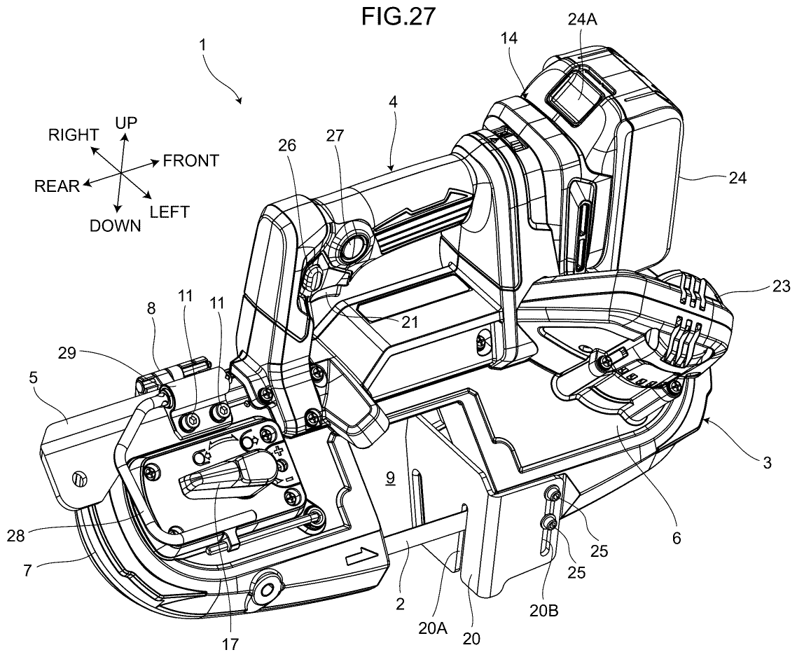

FIG. 24 is a perspective view from the front-upper left side, illustrating a bandsaw 1 according to the embodiment. FIG. 25 is a view of the bandsaw 1 according to the embodiment, as viewed from the right side. FIG. 26 is an exploded view of the bandsaw 1 according to the embodiment, as viewed from the right side. FIG. 27 is a perspective view from the rear-upper left side, illustrating the bandsaw 1 according to the embodiment. Arrows indicating “front”, “rear”, “left”, “right”, “up”, and “down” in FIGS. 24, 25, 26, and 27 indicate directions when it is assumed that the bandsaw 1 is positioned at the bottom dead center of an attachment arm 34 described later with the bandsaw 1 attached to the attachment arm 34.

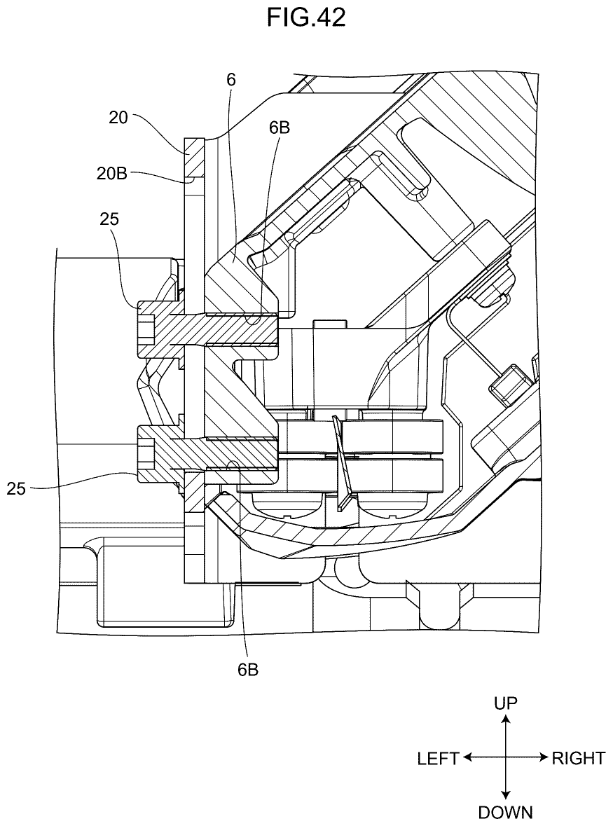

A stopper plate 20 is fixed to a base housing 6 by two screws 25. The screws 25 are inserted into a slit 20B provided in the stopper plate 20. The slit 20B is long in the up-down direction. After being inserted into the slit 20B, the screws 25 are inserted into threaded holes 6B (see FIG. 42) provided in the base housing 6. The screws 25 are inserted, via the slit 20B, into the threaded holes 6B provided in the base housing 6, whereby the stopper plate 20 is fixed to the base housing 6. The position of the stopper plate 20 in the up-down direction with respect to the base housing 6 is adjustable.

### Stand

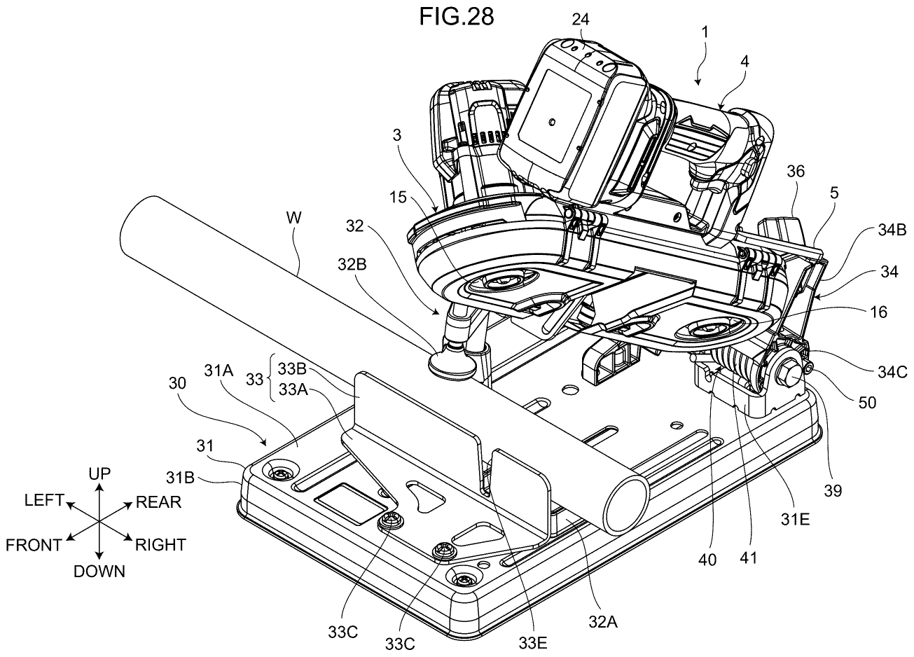

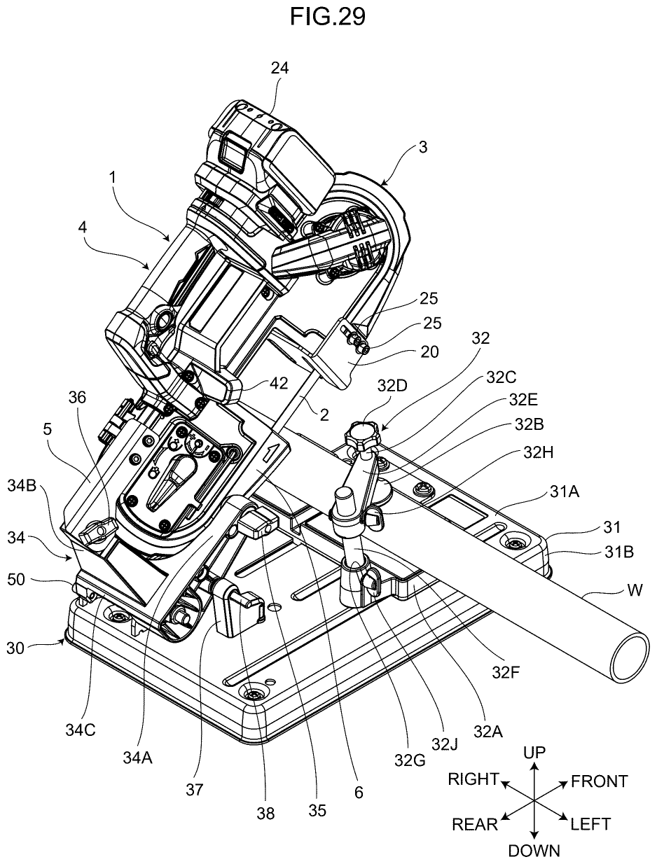

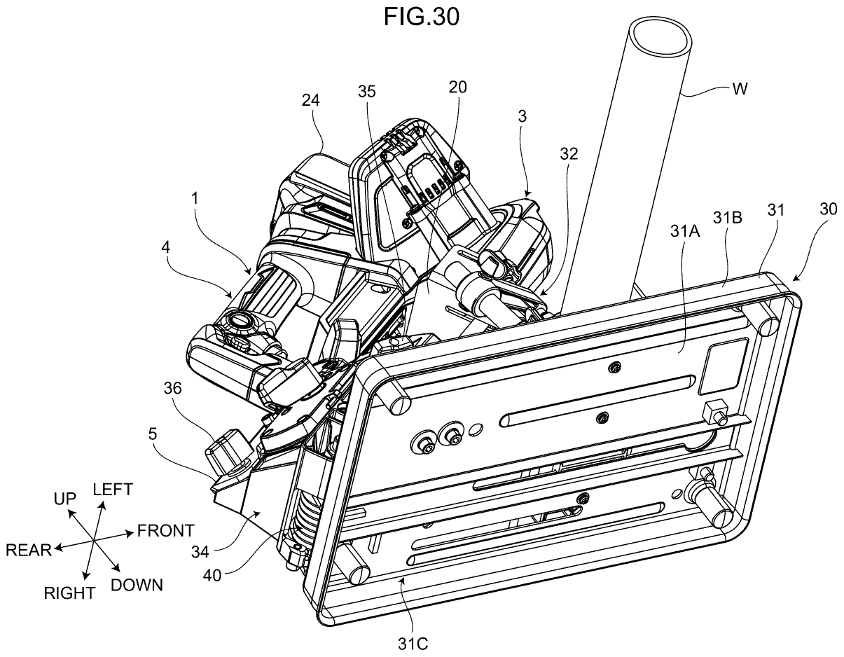

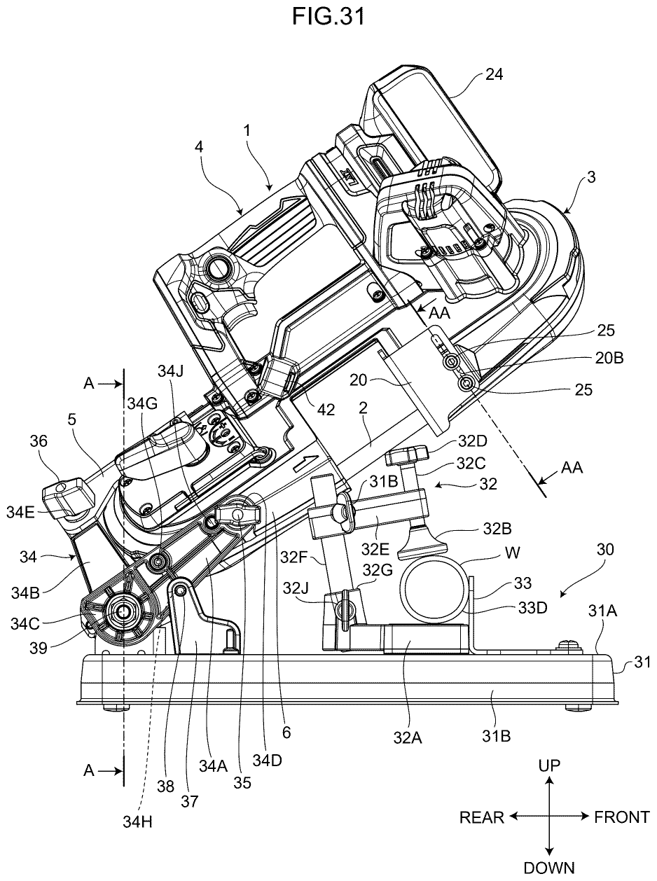

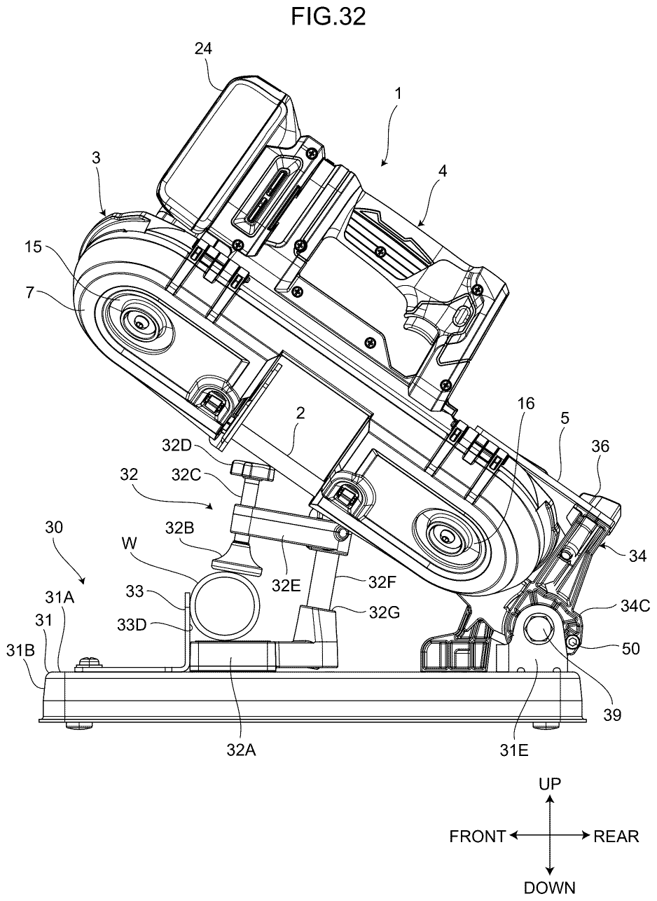

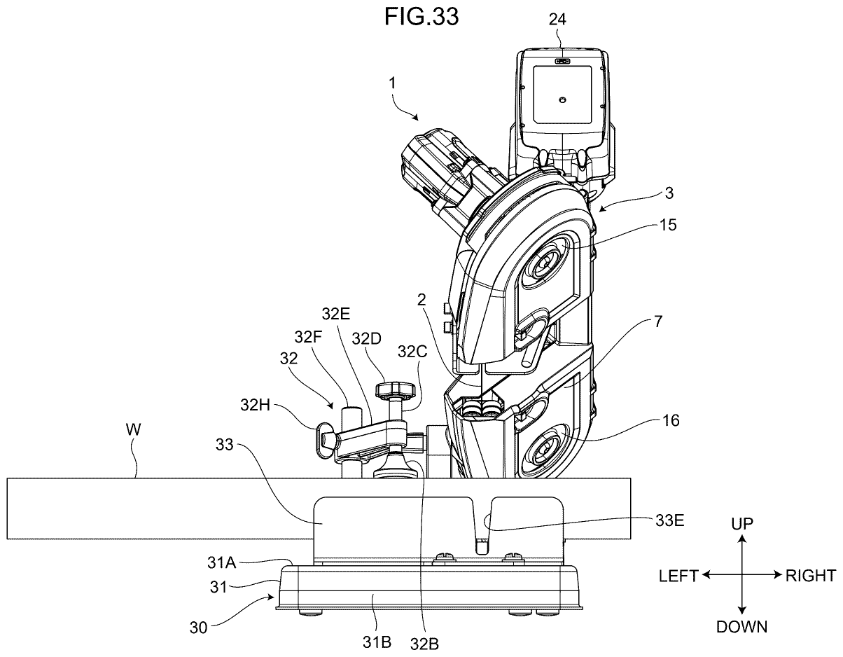

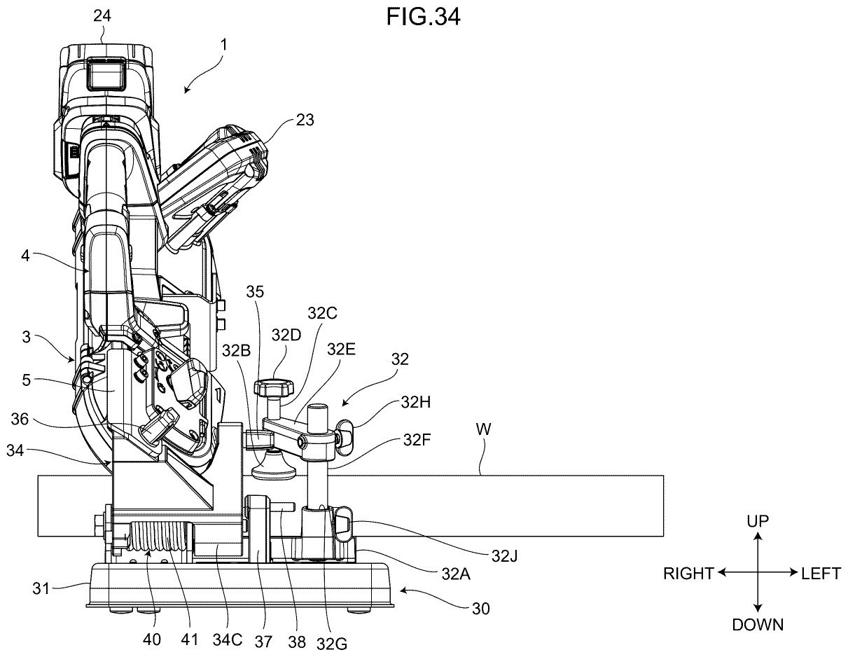

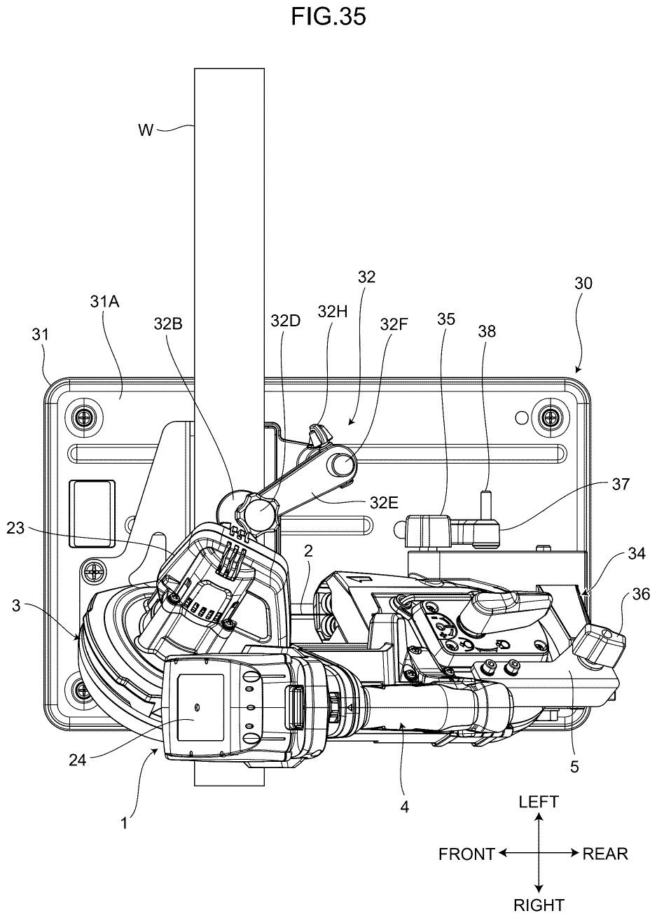

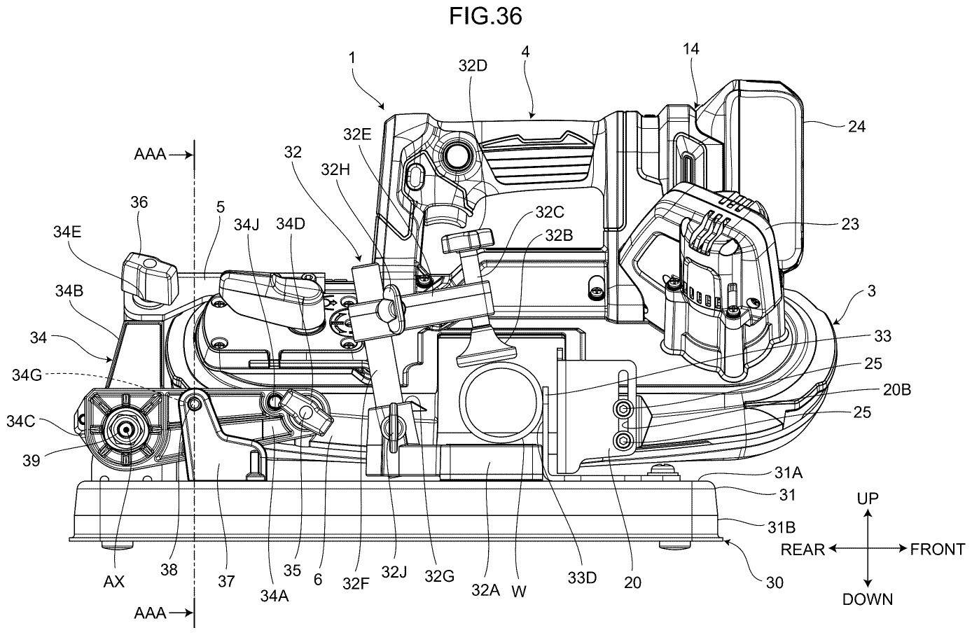

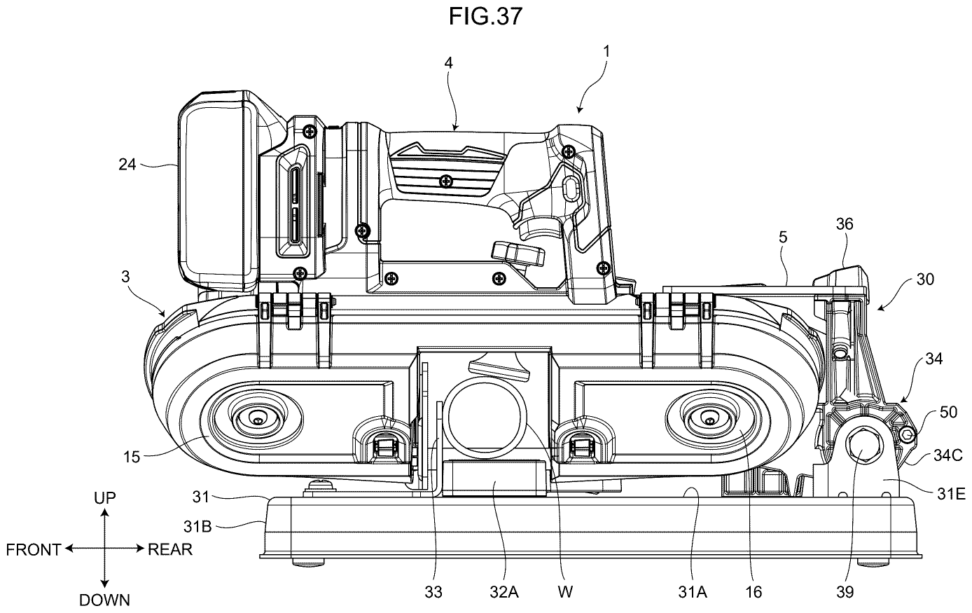

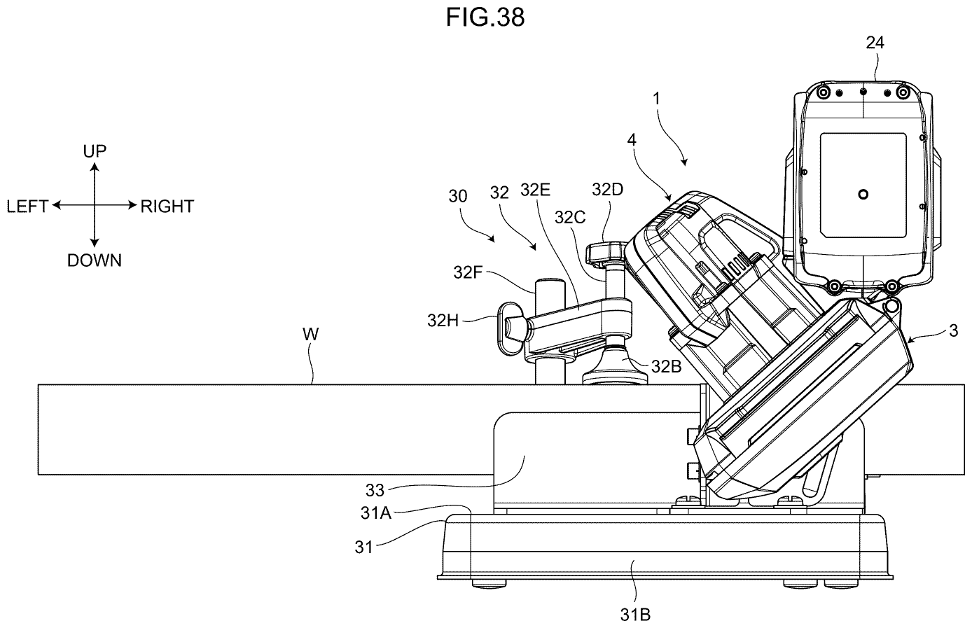

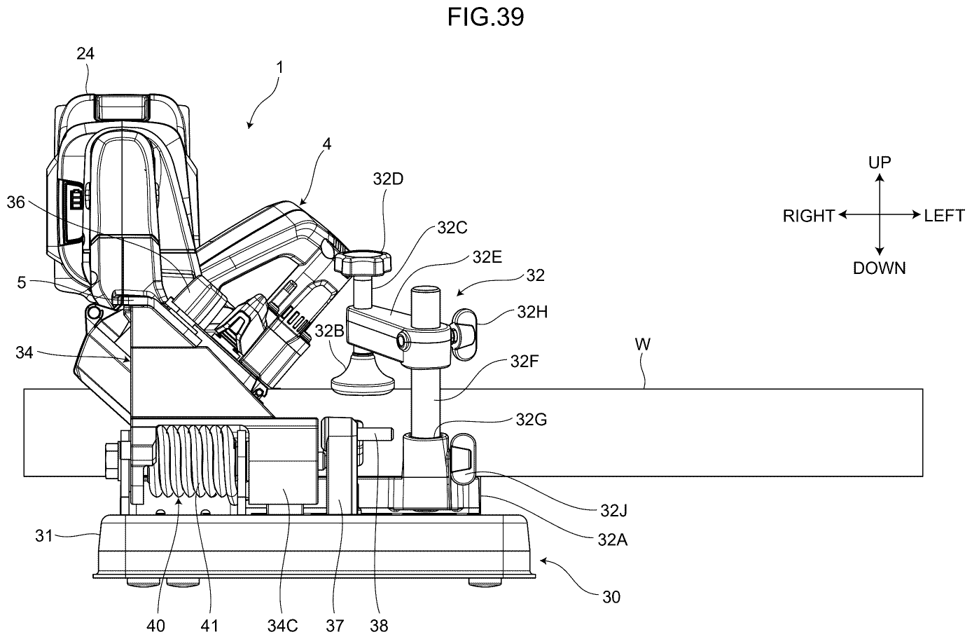

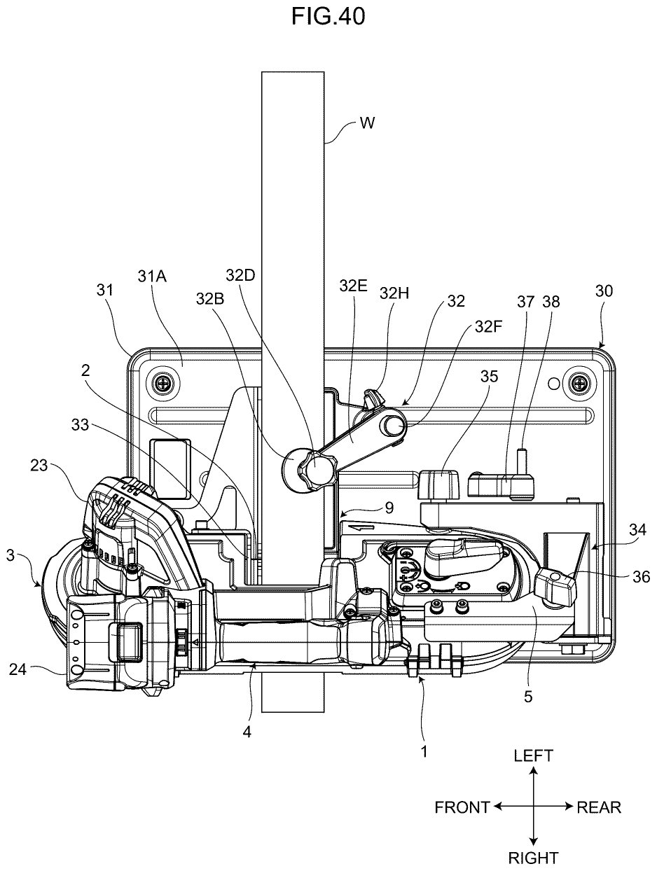

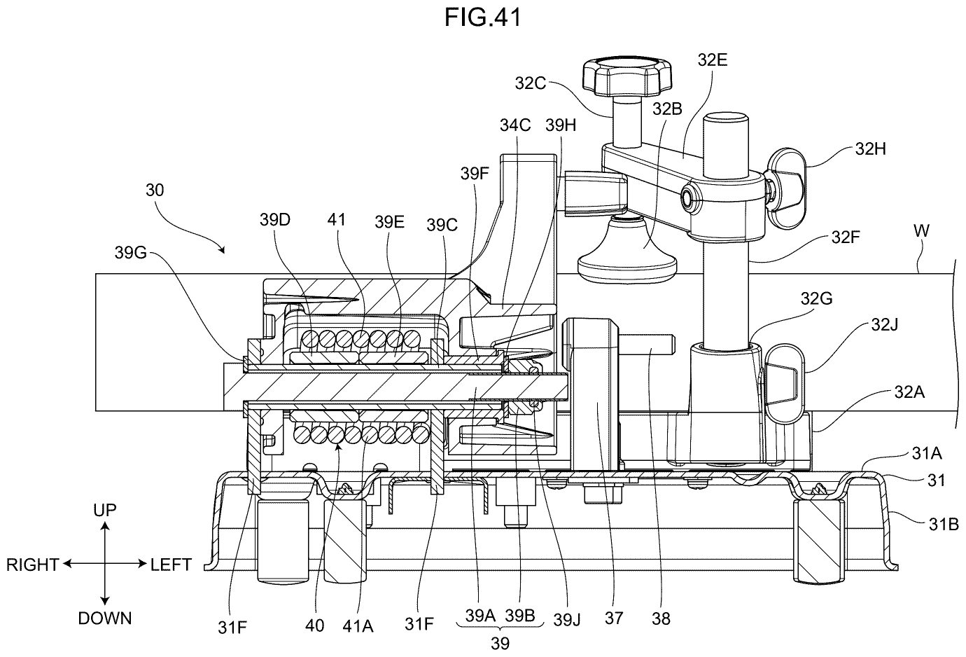

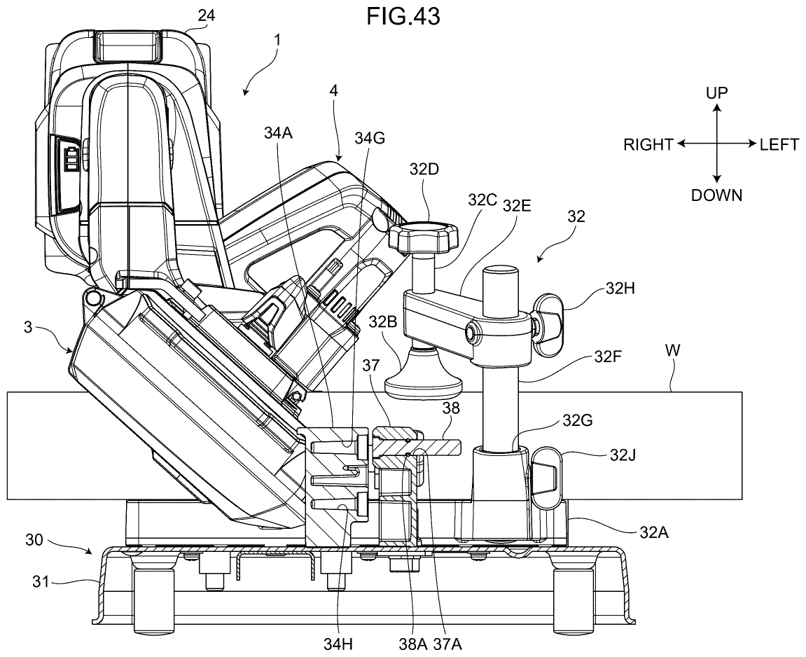

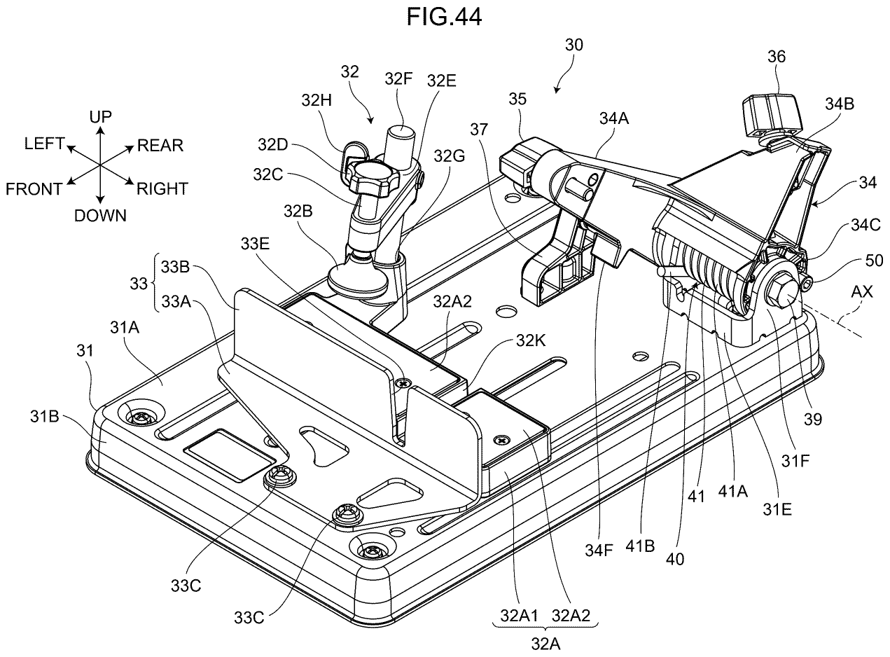

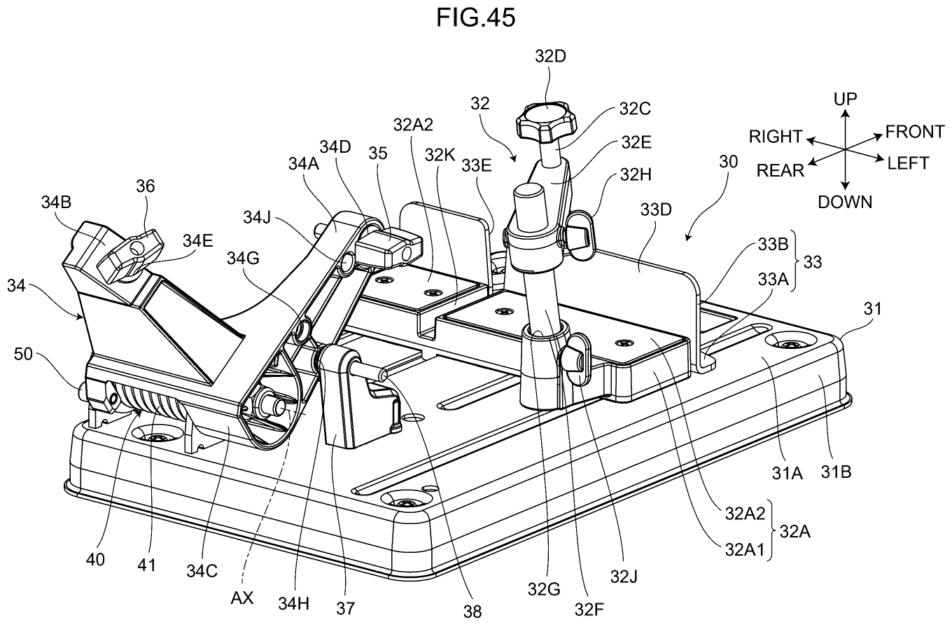

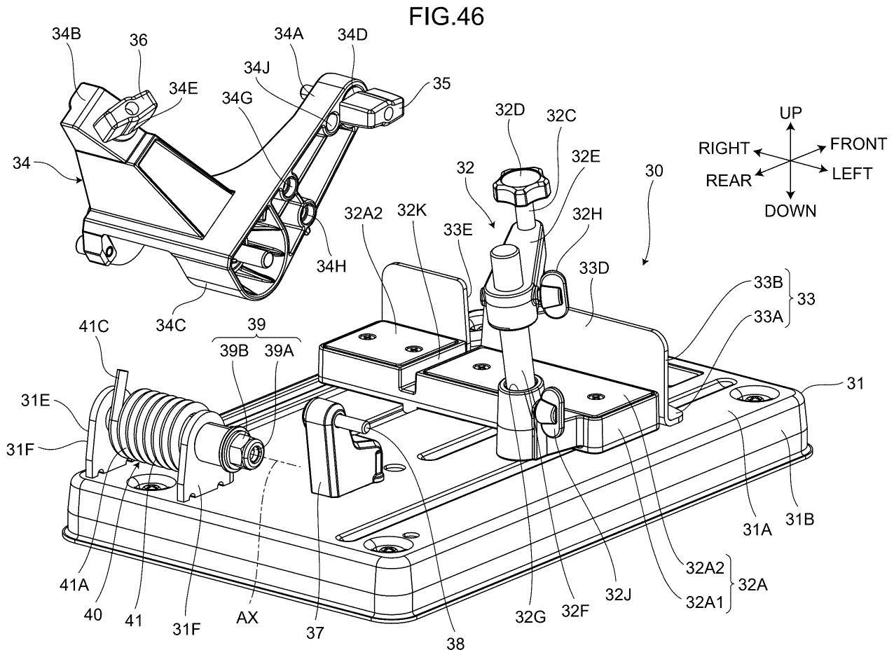

FIG. 28 is a perspective view from the front-upper right side, illustrating a stand 30, according to the embodiment, to which the bandsaw 1 is attached. FIG. 29 is a perspective view from the rear-upper left side, illustrating the stand 30, according to the embodiment, to which the bandsaw 1 is attached. FIG. 30 is a perspective view from the rear-lower left side, illustrating the stand 30, according to the embodiment, to which the bandsaw 1 is attached. FIG. 31 is a view of the stand 30, according to the embodiment, to which the bandsaw 1 is attached, as viewed from the left side. FIG. 32 is a view of the stand 30, according to the embodiment, to which the bandsaw 1 is attached, as viewed from the right side. FIG. 33 is a view of the stand 30, according to the embodiment, to which the bandsaw 1 is attached, as viewed from the front side. FIG. 34 is a view of the stand 30, according to the embodiment, to which the bandsaw 1 is attached, as viewed from behind. FIG. 35 is a view of the stand 30, according to the embodiment, to which the bandsaw 1 is attached, as viewed from above. FIG. 36 is a view of the stand 30, according to the embodiment, to which the bandsaw 1 is attached, as viewed from the left side. FIG. 37 is a view of the stand 30, according to the embodiment, to which the bandsaw 1 is attached, as viewed from the right side. FIG. 38 is a view of the stand 30, according to the embodiment, to which the bandsaw 1 is attached, as viewed from the front side. FIG. 39 is a view of the stand 30, according to the embodiment, to which the bandsaw 1 is attached, as viewed from behind. FIG. 40 is a view of the stand 30, according to the embodiment, to which the bandsaw 1 is attached, as viewed from above. FIG. 41 is a sectional view illustrating a part of the stand 30 according to the embodiment and corresponding to a sectional view taken along line A-A in FIG. 31. FIG. 42 is a sectional view illustrating a part of the stand 30 according to the embodiment and corresponding to a sectional view taken along line AA-AA in FIG. 31. FIG. 43 is a sectional view illustrating a part of the stand 30 according to the embodiment and corresponding to a sectional view taken along line AAA-AAA in FIG. 36. FIG. 44 is a perspective view from the front-upper right side, illustrating the stand 30 according to the embodiment. FIG. 45 is a perspective view from the rear-upper left side, illustrating the stand 30 according to the embodiment. FIG. 46 is an exploded perspective view from the rear-upper left side, illustrating the stand 30 according to the embodiment.

FIGS. 28, 29, 30, 31, 32, 33, 34, and 35 each illustrate a state in which the attachment arm 34, to which the bandsaw 1 is attached, is positioned at the top dead center. FIGS. 36, 37, 38, 39, and 40 each illustrate the state in which the attachment arm 34, to which the bandsaw 1 is attached, is positioned at the bottom dead center. FIGS. 44, 45, and 46 each illustrate the state in which the attachment arm 34 is positioned at the top dead center.

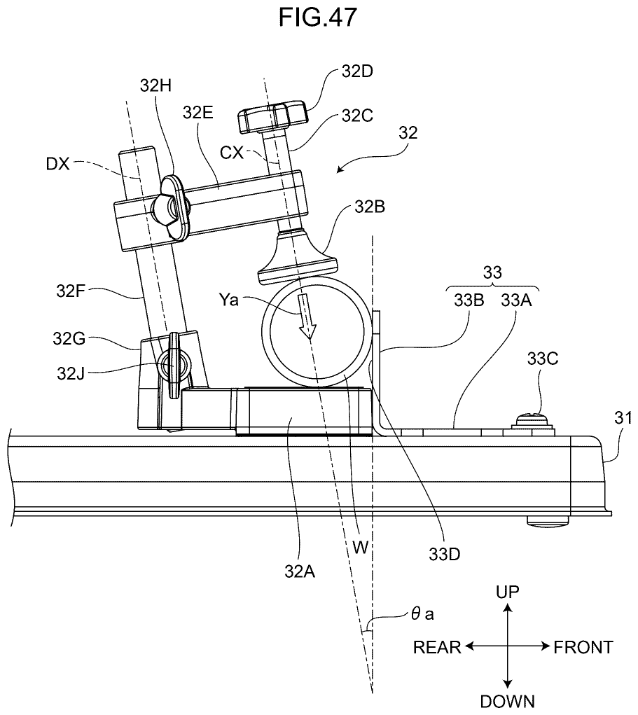

FIG. 47 is a view of a part of the stand 30 according to the embodiment, as viewed from the left side. As illustrated in FIGS. 44, 45, and 47, a vise 32 includes an abutment member 32B, a clamping rod 32C, an operation member 32D, a vise arm 32E, a guide rod 32F, a first thumb screw 32H, and a second thumb screw 32J.

The vise 32 is attachable to a support table 32A. The support table 32A is fixed to an upper surface of a base 31. The outer shape of the support table 32A is substantially rectangular parallelepiped. The support table 32A has an upper surface that supports a workpiece W. The support table 32A supports the workpiece W from below. The upper surface of the support table 32A is orthogonal to the up-down axis. The workpiece W is placed on the upper surface of the support table 32A. The support table 32A includes a block portion 32A1 that is made of aluminum and is fixed to the upper surface of the base 31, and a plate portion 32A2 that is made of steel and is fixed to an upper surface of the block portion 32A1. The upper surface of the support table 32A includes an upper surface of the plate portion 32A2. The workpiece W comes into contact with the upper surface of the plate portion 32A2. Since the block portion 32A1 is made of aluminum, the weight of the support table 32A can be made lighter. Since the plate portion 32A2 with which the workpiece W comes into contact is made of steel, wear of the support table 32A is suppressed.

A groove 32K is provided more rightward than the center of the support table 32A in the left-right direction. The groove 32K is long in the front-rear direction. When the bandsaw 1 is positioned at the bottom dead center, a blade 2 is inserted into the groove 32K.

The abutment member 32B is connected to a lower end of the clamping rod 32C to be rotatable about a central axis CX. The abutment member 32B is fixed to the lower end of the clamping rod 32C. The abutment member 32B faces the support table 32A. The abutment member 32B is disposed above the support table 32A. The abutment member 32B comes into contact with the workpiece W.

The clamping rod 32C is fixed to an upper portion of the abutment member 32B. The central axis CX of the clamping rod 32C is inclined with respect to the up-down axis. In the embodiment, the clamping rod 32C includes a threaded portion. The clamping rod 32C is what is called a vise screw in which screw threads are provided on the outer peripheral surface of the clamping rod 32C.

The operation member 32D is connected to an upper end of the clamping rod 32C. The operation member 32D is fixed to the upper end of the clamping rod 32C. The operation member 32D is operated by a user. The user can rotate the operation member 32D. The operation member 32D is rotated, whereby the clamping rod 32C rotates about the central axis CX while moving ahead or back (advancing or retracting). The clamping rod 32C rotates and moves ahead (advances) when the abutment member 32B is in contact with the workpiece W, whereby the abutment member 32B moves ahead (advances) without rotating.

The clamping rod 32C is rotatably supported by the vise arm 32E. The vise arm 32E has a threaded hole in which the clamping rod 32C is disposed. The operation member 32D is operated such that the clamping rod 32C rotates, whereby the clamping rod 32C moves in a direction parallel to the central axis CX. The clamping rod 32C rotates, whereby the abutment member 32B moves together with the clamping rod 32C.

The guide rod 32F guides the vise arm 32E. A central axis DX of the guide rod 32F is inclined with respect to the up-down axis. The guide rod 32F guides the vise arm 32E in a direction parallel to the central axis DX. The vise arm 32E is movable in the direction parallel to the central axis DX with respect to the guide rod 32F.

The guide rod 32F is inclined in the same direction as the clamping rod 32C is. The central axis CX of the clamping rod 32C is parallel to the central axis DX of the guide rod 32F.

The support table 32A includes a rod support portion 32G to which the guide rod 32F is attached. The rod support portion 32G protrudes upward from the upper surface of the support table 32A. The rod support portion 32G has a recess into which a lower end of the guide rod 32F is inserted. The lower end of the guide rod 32F is rotatably supported by the rod support portion 32G. In the embodiment, the rod support portion 32G is integrated with the block portion 32A1 of the support table 32A. The rod support portion 32G and the block portion 32A1 are a single member. The guide rod 32F is supported by the rod support portion 32G to be rotatable about the central axis DX of the guide rod 32F.

The first thumb screw 32H is rotated in one direction, thereby fixing the vise arm 32E and the guide rod 32F. The first thumb screw 32H is rotated in the other direction, thereby releasing the fixation between the vise arm 32E and the guide rod 32F.

The second thumb screw 32J is rotated in one direction, thereby fixing the guide rod 32F and the rod support portion 32G. The second thumb screw 32J is rotated in the other direction, thereby releasing the fixation between the guide rod 32F and the rod support portion 32G.

When fixing the workpiece W with the vise 32, the workpiece W is placed on the upper surface of the support table 32A, and the clamping rod 32C is subsequently rotated such that the abutment member 32B approaches the workpiece W. The user can move the abutment member 32B by pinching and rotating the operation member 32D with his/her fingers. The abutment member 32B moves so as to approach the workpiece W in a state in which the workpiece W is disposed between the support table 32A and the abutment member 32B, whereby the workpiece W is clamped between the support table 32A and the abutment member 32B. This allows the workpiece W to be fixed to the vise 32.

The user releases the fixation of the vise arm 32E by the first thumb screw 32H and moves the vise arm 32E, whereby the user can adjust the position of the abutment member 32B with respect to the support table 32A. In addition, the fixation of the vise arm 32E by the first thumb screw 32H is released and the vise arm 32E is turned about the central axis DX, whereby the position of the abutment member 32B can be adjusted in the horizontal direction (left-right direction) with respect to the support table 32A. The user releases the fixation of the guide rod 32F by the second thumb screw 32J and rotates the guide rod 32F about the central axis DX, whereby the user can adjust the position of the abutment member 32B in the horizontal direction (left-right direction) with respect to the support table 32A.

A fence 33 is provided on the upper surface of the base 31. The fence 33 supports the workpiece W placed on the support table 32A from the side. In the embodiment, the fence 33 supports the workpiece W placed on the support table 32A from the front side (user side). The fence 33 has a plate shape. The fence 33 is formed by bending a plate made of metal. The fence 33 includes a fixing portion 33A that is fixed to the base 31, and a facing portion 33B facing the workpiece W. The fixing portion 33A is fixed to an upper plate portion 31A by screws 33C. The facing portion 33B has an abutment surface 33D facing the workpiece W. The abutment surface 33D supports the workpiece W from the side. The workpiece W is fixed to the vise 32 while being in contact with at least a part of the abutment surface 33D. The abutment surface 33D is orthogonal to the front-rear axis. The abutment surface 33D faces the rear side (counter-user side). The vise 32 is disposed rearward (counter-user side) of the abutment surface 33D. The abutment surface 33D of the fence 33 supports the workpiece W from the front side (user side).

The attachment arm 34 includes a cylindrical portion 34C, a first arm portion 34A, and a second arm portion 34B. The cylindrical portion 34C is disposed around a swing fulcrum AX. The cylindrical portion 34C pivots about the swing fulcrum AX. The first arm portion 34A extends forward (user side) from the cylindrical portion 34C. The second arm portion 34B extends upward from the cylindrical portion 34C. Each of the first arm portion 34A and the second arm portion 34B turns around the swing fulcrum AX. Each of the first arm portion 34A and the second arm portion 34B is fixed to the bandsaw 1.

A washer 39G is disposed between the head of a bolt 39A and a support portion 31F on the right side. A washer 39H is disposed between a sleeve 39F and a nut 39B. Used as the nut 39B is an anti-loosening nut (nylon nut: JIS B1199-1) in which an O-ring 39J made of polyamide is provided, as a synthetic resin member, in a circular annular groove at the mouth of its threaded hole, for example.

As illustrated in FIGS. 43, 45, and 46, the first arm portion 34A has an insertion hole 34G for the bottom dead center and an insertion hole 34H for the top dead center. Each of the insertion hole 34G for the bottom dead center and the insertion hole 34H for the top dead center is provided so as to be recessed rightward from a left surface of the first arm portion 34A. The insertion hole 34G for the bottom dead center is disposed upward of the insertion hole 34H for the top dead center.

As illustrated in FIG. 42, the stopper plate 20 is fixed to the base housing 6 by the two screws 25. The screws 25 are inserted into the slit 20B provided in the stopper plate 20. The slit 20B is long in the up-down direction. After being inserted into the slit 20B, the screws 25 are inserted into the threaded holes 6B provided in the base housing 6. The screws 25 are inserted, via the slit 20B, into the threaded holes 6B provided in the base housing 6, whereby the stopper plate 20 is fixed to the base housing 6.

The position of the stopper plate 20 in the up-down direction with respect to the base housing 6 is adjustable. The slit 20B is long in the up-down direction. The stopper plate 20 is movable in the up-down direction while the slit 20B is guided by the screws 25 in a state in which the fixation by the screws 25 is released and tips of the screws 25 are inserted into the threaded holes 6B. After the stopper plate 20 is moved in the up-down direction in the state in which the fixation of the stopper plate 20 by the screws 25 is released, the screws 25 are pivoted in one direction, whereby the stopper plate 20 is fixed at a certain position in the up-down direction. When attaching the bandsaw 1 to the stand 30, the stopper plate 20 is positioned at the uppermost position in a movable area of the stopper plate 20. That is, when attaching the bandsaw 1 to the stand 30, the stopper plate 20 is fixed to a housing 3 such that an amount of downward protrusion from a lower end of the housing 3 becomes the smallest.

### Vise

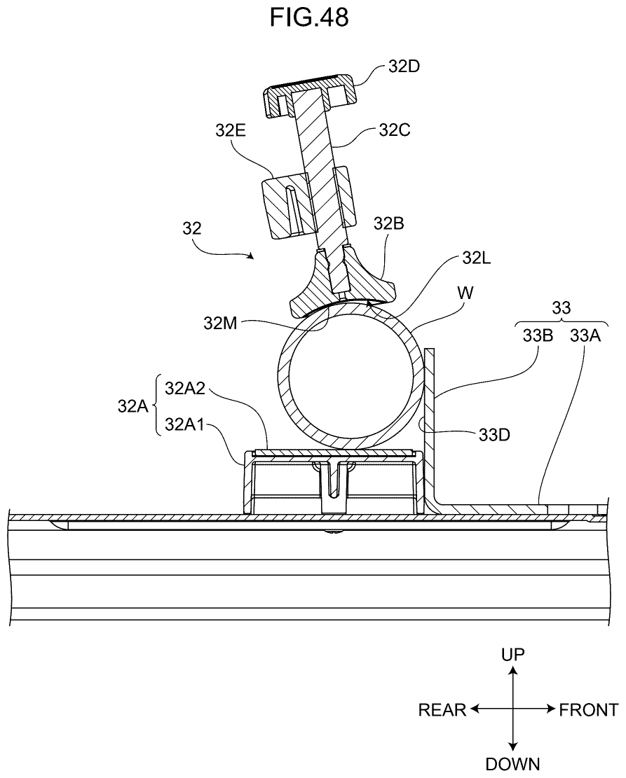

FIG. 48 is a sectional view illustrating a part of the stand 30 according to the embodiment. As illustrated in FIGS. 47 and 48, the fence 33 and the vise 32 are provided on the base 31. The fence 33 has the abutment surface 33D that supports the workpiece W. The abutment surface 33D faces the rear side (counter-user side). The abutment surface 33D is a flat surface. The abutment surface 33D is orthogonal to the front-rear axis. The abutment surface 33D is parallel to each of the up-down axis and the left-right axis.

The vise 32 fixes the workpiece W. The vise 32 is disposed rearward (counter-user side) of the abutment surface 33D.

The vise 32 includes: the support table 32A that is fixed to the upper surface of the base 31; the clamping rod 32C; the abutment member 32B that is coupled to the lower end (one end) of the clamping rod 32C and comes into contact with the workpiece W; the operation member 32D that is connected to the upper end (the other end) of the clamping rod 32C; the vise arm 32E that supports the clamping rod 32C; the guide rod 32F that supports the vise arm 32E; the first thumb screw 32H; and the second thumb screw 32J.

The support table 32A is disposed rearward (counter-user side) of the abutment surface 33D. The support table 32A has the upper surface that supports the workpiece W. The support table 32A supports the workpiece W from below. The upper surface of the support table 32A is a flat surface. The upper surface of the support table 32A is orthogonal to the up-down axis. The upper surface of the support table 32A is parallel to each of the front-rear axis and the left-right axis. The workpiece W is placed on an upper surface of the support table 32A. The support table 32A includes the block portion 32A1 that is made of aluminum and is fixed to the upper surface of the base 31, and the plate portion 32A2 that is made of steel and is fixed to the upper surface of the block portion 32A1. The upper surface of the support table 32A includes the upper surface of the plate portion 32A2.

The abutment member 32B, the clamping rod 32C, and the operation member 32D are disposed rearward (counter-user side) of the abutment surface 33D. The abutment member 32B is disposed at a position closer to the abutment surface 33D than the operation member 32D in the front-rear direction. The abutment member 32B is disposed forward (user side) of the operation member 32D. The position of the center of the abutment member 32B and the position of the center of the operation member 32D are substantially equal in the left-right direction.

The central axis CX of the clamping rod 32C is inclined with respect to the up-down axis. The central axis CX of the clamping rod 32C is inclined with respect to the abutment surface 33D on a predetermined plane including the up-down axis and the front-rear axis. The central axis CX of the clamping rod 32C is parallel to the predetermined plane. The central axis CX of the clamping rod 32C is inclined upward so as to be away from the abutment surface 33D.

An angle θa formed by the abutment surface 33D of the fence 33 and the central axis CX of the clamping rod 32C on the predetermined plane is 1 degree or more and 45 degrees or less. The angle θa may be 5 degrees or more and 20 degrees or less. The angle θa may be 10 degrees or more and 15 degrees or less. In the embodiment, the angle θa is 10 degrees. The angle θa is an angle formed by the up-down axis and the central axis CX on the predetermined plane. The central axis CX is slightly inclined with respect to the up-down axis.

The clamping rod 32C is rotatably supported by the vise arm 32E. In the embodiment, the clamping rod 32C is a screw shaft. The vise arm 32E has the threaded hole in which the clamping rod 32C is disposed. The operation member 32D is operated such that the clamping rod 32C rotates, whereby the clamping rod 32C moves in the direction parallel to the central axis CX. The clamping rod 32C rotates, whereby the abutment member 32B moves together with the clamping rod 32C.

The guide rod 32F guides the vise arm 32E in the direction parallel to the central axis DX. The central axis DX of the guide rod 32F is inclined with respect to the abutment surface 33D. The central axis DX of the guide rod 32F is inclined with respect to the abutment surface 33D on a predetermined plane including the up-down axis and the front-rear axis. The central axis DX of the guide rod 32F is parallel to the predetermined plane. The central axis DX of the guide rod 32F is inclined upward so as to be away from the abutment surface 33D.

The guide rod 32F is inclined in the same direction as the clamping rod 32C is. The central axis CX of the clamping rod 32C is parallel to the central axis DX of the guide rod 32F.

An angle θb formed by the up-down direction parallel to the abutment surface 33D of the fence 33 and the central axis DX of the guide rod 32F on the predetermined plane may be 1 degree or more and 45 degrees or less. The angle θb may be 5 degrees or more and 20 degrees or less. The angle θb may be 10 degrees or more and 15 degrees or less. In the embodiment, the angle θb is 10 degrees, which is the same as the angle θa. The angle θb is an angle formed by the up-down axis and the central axis DX on the predetermined plane. The central axis DX is slightly inclined with respect to the up-down axis.

The support table 32A includes the rod support portion 32G to which the guide rod 32F is attached. The rod support portion 32G protrudes upward from the upper surface of the support table 32A. The rod support portion 32G has the recess into which the lower end of the guide rod 32F is inserted. The lower end of the guide rod 32F is rotatably supported by the rod support portion 32G.

The abutment member 32B is an elastic body made of rubber. A rubber hardness of the abutment member 32B is 80 or more and 90 or less. In the present specification, the rubber hardness is a durometer A hardness measured under a standard temperature of 23±2° C. by a durometer type A according to JIS-K6253. Note that the abutment member 32B may be an elastic body made of synthetic resin.

The outer shape of the abutment member 32B is substantially conical. The central axis of the abutment member 32B and the central axis CX of the clamping rod 32C coincide with each other. The diameter of the abutment member 32B gradually decreases toward an upper end of the abutment member 32B.

As illustrated in FIG. 48, a facing portion, of the abutment member 32B, facing the workpiece W includes a recess 32L that is recessed so as to be away from the workpiece W. The facing portion of the abutment member 32B has a lower surface of the conical abutment member 32B. An inner surface 32M of the recess 32L has a curved shape. In the embodiment, the inner surface 32M of the recess 32L has a spherical shape. The inner surface 32M of the recess 32L may be another curved surface, such as a quadric surface other than the spherical surface. The shape may be a combination of two curved surfaces, such as a spherical surface and a cylinder, and a spherical surface and a cone.

When fixing the workpiece W with the vise 32, the workpiece W is placed on the upper surface of the support table 32A, and the clamping rod 32C is subsequently rotated such that the abutment member 32B approaches the workpiece W. The user operates the operation member 32D such that the clamping rod 32C rotates. The clamping rod 32C rotates, whereby the abutment member 32B moves so as to approach the workpiece W. Since the angle θa is 45 degrees or less, the distance between the user positioning on the front side (user side) of the stand 30 and the operation member 32D is inhibited from being lengthened. The user positioning on the front side (user side) of the stand 30 can smoothly operate the operation member 32D.

The abutment member 32B moves so as to approach the workpiece W in the state in which the workpiece W is disposed between the support table 32A and the abutment member 32B, whereby the workpiece W is clamped between the support table 32A and the abutment member 32B. This allows the workpiece W to be fixed to the vise 32. In the embodiment, since the central axis CX of the clamping rod 32C is inclined with respect to the abutment surface 33D, force in an oblique direction acts on the workpiece W from the abutment member 32B as indicated by an arrow Ya in FIG. 47. The rotation of the clamping rod 32C causes the abutment member 32B to move so as to press the workpiece W against each of the upper surface of the support table 32A and the abutment surface 33D of the fence 33. The abutment member 32B presses the workpiece W against each of the upper surface of the support table 32A and the abutment surface 33D of the fence 33. This enables the vise 32 to stably fix the workpiece W even if the workpiece W is a round pipe.

In the embodiment, since the abutment member 32B is an elastic body, a contact area between the abutment member 32B and the workpiece W increases due to elastic deformation of the abutment member 32B when the abutment member 32B is pressed against the workpiece W. In addition, the abutment member 32B is appropriately deformed by the recess 32L provided in a lower portion of the abutment member 32B. This enables the vise 32 to stably fix the workpiece W.

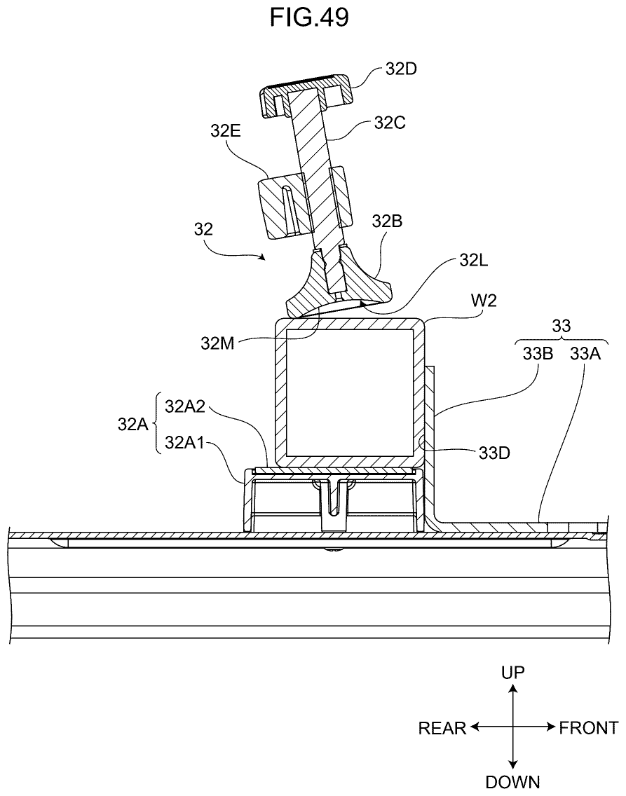

FIG. 49 is a sectional view illustrating a part of the stand 30 according to the embodiment. FIG. 49 illustrates an example in which a workpiece W2 is a square pipe (square member). Since the abutment member 32B is an elastic body and has the recess 32L, even if the workpiece W2 is a square pipe, a contact area between the abutment member 32B and the workpiece W2 increases due to the elastic deformation of the abutment member 32B when the abutment member 32B is pressed against the workpiece W2. This enables the vise 32 to stably fix the workpiece W2.

### Method of Using Bandsaw

Next, a method of using the bandsaw 1 will be described. In the normal use state, the user positions (stands)on the front side of the bandsaw 1 and grips a handle 4 with the right hand. When the user positions (stands) on the front side of the bandsaw 1 and grips the handle 4 with the right hand, a cutting portion of the blade 2 is disposed leftward of the handle 4. The user can see the cutting portion of the blade 2 while gripping the handle 4 with the right hand.

When cutting the workpiece W in the normal use state, the user pulls a main switch 21 with a finger of the right hand gripping the handle 4. The main switch 21 is pulled, whereby a motor 13 is driven to rotate the blade 2. In the state in which the blade 2 is rotating, the user presses the blade 2 disposed in an opening 9 against the workpiece W, whereby the workpiece W is cut. When cutting the workpiece W, the workpiece W is supported by the stopper plate 20 from the front side.

The stopper plate 20 is not used when using the stand. When attaching the bandsaw 1 to the stand 30, the user rotates the screws 25 so as to release the fixation of the stopper plate 20, and subsequently adjusts the position of the stopper plate 20 such that the amount of downward protrusion of the stopper plate 20 from the lower end of the housing 3 becomes the smallest. After adjusting the position of the stopper plate 20 such that the amount of downward protrusion of the stopper plate 20 from the lower end of the housing 3 becomes the smallest, the user rotates the screws 25 such that the stopper plate 20 is fixed.

When using the stand, the bandsaw 1 is attached to the attachment arm 34. The user fixes the base housing 6 of the bandsaw 1 and the first arm portion 34A with a first fastener 35, and fixes a plate 5 of the bandsaw 1 and the second arm portion 34B with a second fastener 36. The user places the workpiece W on the support table 32A such that the workpiece W is in contact with the abutment surface 33D of the fence 33, and subsequently fixes the workpiece W with the vise 32. The workpiece W is supported by the fence 33 from the front side.

After attaching the bandsaw 1 to the attachment arm 34 and fixing the workpiece W with the vise 32, the user positions on the front side of the bandsaw 1 and grips the handle 4 with the right hand. When the user positions on the front side of the bandsaw 1 and grips the handle 4 with the right hand, a cutting portion of the blade 2 is disposed leftward of the handle 4. The user can see the cutting portion of the blade 2 while gripping the handle 4 with the right hand.

When cutting the workpiece W using the stand, the user pulls the main switch 21 with a finger of the right hand gripping the handle 4. The main switch 21 is pulled, whereby the motor 13 is driven to rotate the blade 2. In the state in which the blade 2 is rotating, the user moves the handle 4 downward such that the attachment arm 34 moves to the bottom dead center. The handle 4 moves downward, whereby the blade 2 disposed in the opening 9 approaches the workpiece W. The blade 2 disposed in the opening 9 is pressed against the workpiece W, whereby the workpiece W is cut. When cutting the workpiece W, the workpiece W is supported by the fence 33 from the front side.

A battery pack 24 is disposed forward (user side) of the center of the housing 3 in the front-rear direction. Hence, when the bandsaw 1 is moved to the bottom dead center, the weight of the battery pack 24 facilitates the movement of the bandsaw 1 to the bottom dead center.

After the bandsaw 1 moves to the bottom dead center and the workpiece W is cut by the blade 2, the user releases the operation of the main switch 21 to stop the motor 13. After the motor 13 is stopped, the user removes the hand from the bandsaw 1 or loosens the downward force pressing against the bandsaw 1, whereby the attachment arm 34 to which the bandsaw 1 is attached is automatically returned to the top dead center by the return device 40.

For example, when replacing the blade 2 with new one with the bandsaw 1 attached to the attachment arm 34, the user inserts a lock member 38 into the insertion hole 34H for the top dead center. The lock member 38 is inserted into the insertion hole 34H for the top dead center, whereby the position of the bandsaw 1 is fixed at the top dead center. The user can, for example, replace the blade 2 in the state in which the position of the bandsaw 1 is fixed to the top dead center.

For example, in a case of transporting or storing the stand 30, the user inserts the lock member 38 into the insertion hole 34G for the bottom dead center. The lock member 38 is inserted into the insertion hole 34G for the bottom dead center, whereby the position of the stand 30 is fixed to the bottom dead center. The user can, for example, transport or store the stand 30 with the stand 30 made compact.

### Effects

As described above, in the embodiment, the stand 30 to which the bandsaw 1 is attached includes: the base 31; the fence 33 that is provided on the base 31 and has the abutment surface 33D supporting the workpiece W; and the vise 32 that is provided on the base 31 and fixes the workpiece W. The abutment surface 33D faces the rear side (counter-user side). The vise 32 is disposed rearward (counter-user side) of the abutment surface 33D. The vise 32 includes the clamping rod 32C, the abutment member 32B that is connected to the one end of the clamping rod 32C and comes into contact with the workpiece W, and the operation member 32D that is connected to the other end of the clamping rod 32C. The abutment member 32B is disposed at a position closer to the abutment surface 33D than the operation member 32D.

With the above configuration, when cutting the workpiece W with the blade 2 of the bandsaw 1, if the workpiece W moves to the front side (user side) due to force of the blade 2 transmitted in the direction of the user, the workpiece W is appropriately supported by the abutment surface 33D, of the fence 33, facing the rear side (counter-user side). The workpiece W positioned against the fence 33 is appropriately fixed by the vise 32 disposed rearward (counter-user side) of the abutment surface 33D of the fence 33. Since the abutment member 32B of the vise 32 is disposed forward (user side) of the operation member 32D, the workpiece W is pressed against the abutment surface 33D of the fence 33 to be appropriately fixed. The user can operate the operation member 32D with satisfactory operability.

In the embodiment, the angle θa formed by the abutment surface 33D and the clamping rod 32C is 1 degree or more and 45 degrees or less.

With the above configuration, the user can operate the operation member 32D with satisfactory operability, and the workpiece W is appropriately fixed by the vise 32. When the angle θa formed by the abutment surface 33D and the clamping rod 32C is less than 1 degree, there may be a possibility that the force of the abutment member 32B pressing the workpiece W against the abutment surface 33D of the fence 33 is weakened. When the force by which the workpiece W is pressed against the abutment surface 33D of the fence 33 is weakened, a possibility increases that the workpiece W is not appropriately fixed. When the angle θa formed by the abutment surface 33D and the clamping rod 32C exceeds 45 degrees, there is a possibility that the distance between the user positioning on the front side (user side) of the stand 30 and the operation member 32D is lengthened. When the distance between the user and the operation member 32D is lengthened, there is a possibility that the user has difficulty in operating the operation member 32D with satisfactory operability. The angle θa formed by the abutment surface 33D and the clamping rod 32C is set to 1 degree or more and 45 degrees or less, whereby the user can operate the operation member 32D with satisfactory operability, and the workpiece W is appropriately fixed.

In the embodiment, the angle θa formed by the abutment surface 33D and the clamping rod 32C is 5 degrees or more and 20 degrees or less.

With the above configuration, the user can operate the operation member 32D with satisfactory operability, and the workpiece W is appropriately fixed by the vise 32. When the angle θa formed by the abutment surface 33D and the clamping rod 32C is less than 5 degrees, there may be the possibility that the force of the abutment member 32B pressing the workpiece W against the abutment surface 33D of the fence 33 is weakened. When the force by which the workpiece W is pressed against the abutment surface 33D of the fence 33 is weakened, the possibility increases that the workpiece W is not appropriately fixed. When the angle θa formed by the abutment surface 33D and the clamping rod 32C exceeds 20 degrees, there is the possibility that the distance between the user positioning on the front side (user side) of the stand 30 and the operation member 32D is lengthened. When the distance between the user and the operation member 32D is lengthened, there is the possibility that the user has difficulty in operating the operation member 32D with satisfactory operability. The angle θa formed by the abutment surface 33D and the clamping rod 32C is set to 5 degrees or more and 20 degrees or less, whereby the user can operate the operation member 32D with satisfactory operability, and the workpiece W is appropriately fixed.

In the embodiment, the vise 32 is fixed to the upper surface of the base 31 and is attachable to the support table 32A having the upper surface that supports the workpiece W.

With the above configuration, the workpiece W is more appropriately fixed by the abutment surface 33D of the fence 33, the abutment member 32B of the vise 32, and the support table 32A.

In the embodiment, the vise 32 includes the vise arm 32E that supports the clamping rod 32C, and the guide rod 32F that supports the vise arm 32E. The guide rod 32F is inclined in the same direction as the clamping rod 32C is.

With the above configuration, a moment acting on the guide rod 32F from the vise arm 32E is inhibited from becoming excessive. Since the moment acting on the guide rod 32F is small, the force by which the workpiece W is pressed against the abutment surface 33D of the fence 33 is inhibited from changing. Hence, the workpiece W is appropriately fixed.

In the embodiment, the support table 32A includes the rod support portion 32G to which the guide rod 32F is attached.

With the above configuration, the number of components interposed between the upper surface of the support table 32A and the abutment member 32B is inhibited from becoming excessive. The number of components is lessened, whereby the workpiece W is more appropriately fixed by the abutment surface 33D of the fence 33, the abutment member 32B of the vise 32, and the support table 32A.

In the embodiment, the angle θb formed by the abutment surface 33D and the guide rod 32F is 5 degrees or more and 20 degrees or less.

With the above configuration, the user can operate the operation member 32D with satisfactory operability, and the workpiece W is appropriately fixed by the vise 32.

In the embodiment, the abutment member 32B is an elastic body made of rubber or synthetic resin.

With the above configuration, the abutment member 32B can deform in conformity with the shape of the workpiece W.

In the embodiment, the facing portion, of the abutment member 32B, facing the workpiece W includes the recess 32L that is recessed so as to be away from the workpiece W.

With the above configuration, the abutment member 32B can deform in conformity with the outer shape of the workpiece W.

In the embodiment, the inner surface 32M of the recess 32L has a curved shape.

With the above configuration, the abutment member 32B can deform in conformity with the outer shape of the workpiece W.

In the embodiment, the rubber hardness of the abutment member 32B is 80 or more and 90 or less.

With the above configuration, the abutment member 32B can deform suitably in conformity with the shape of the workpiece W.

### Other Embodiments

In the above-described embodiments, the spring 41 of the return device 40 is a torsion spring. The spring 41 of the return device 40 may be a coil spring or a leaf spring.

In the above-described embodiments, the return device 40 includes the spring 41. The return device 40 may include, for example, an air cylinder or an electric motor.

In the above-described embodiments, both the first fastener 35 and the second fastener 36 are thumb screws. One of the first fastener 35 and the second fastener 36 may be a thumb screw, and the other of the first fastener 35 and the second fastener 36 may be a normal screw to be tightened using a tool.

Additional aspects of the present teachings include, but are not limited to:
1. A portable bandsaw stand to which a portable bandsaw is attached, the portable bandsaw stand comprising:
   a base;
   a fence that is provided on the base and has an abutment surface supporting a workpiece; and
   a vise that is provided on the base and fixes the workpiece, wherein
   the abutment surface faces a counter-user side,
   the vise is disposed on the counter-user side of the abutment surface, and includes a clamping rod, an abutment member that is connected to one end of the clamping rod and comes into contact with the workpiece, and an operation member that is connected to another end of the clamping rod, and
   the abutment member is disposed at a position closer to the abutment surface than the operation member.
2. The portable bandsaw stand according to the above aspect 1, wherein
   an angle formed by the abutment surface and the clamping rod is 1 degree or more and 45 degrees or less.
3. The portable bandsaw stand according to the above aspect 1 or 2, wherein
   an angle formed by the abutment surface and the clamping rod is 5 degrees or more and 20 degrees or less.
4. The portable bandsaw stand according to any one of the above aspects 1 to 3, wherein
   the vise is fixed to an upper surface of the base, and is attachable to a support table having an upper surface that supports the workpiece.
5. The portable bandsaw stand according to the above aspect 4, wherein
   the vise includes a vise arm that supports the clamping rod, and a guide rod that supports the vise arm, and
   the guide rod is inclined in the same direction as the clamping rod is.
6. The portable bandsaw stand according to the above aspect 5, wherein
   the support table includes a rod support portion to which the guide rod is attached.
7. The portable bandsaw stand according to the above aspect 5 or 6, wherein
   an angle formed by the abutment surface and the guide rod is 5 degrees or more and 20 degrees or less.
8. The portable bandsaw stand according to any one of the above aspects 1 to 7, wherein
   the abutment member is an elastic body made of rubber or synthetic resin.
9. The portable bandsaw stand according to the above aspect 8, wherein
   a facing portion, of the abutment member, facing the workpiece includes a recess that is recessed so as to be away from the workpiece.
10. The portable bandsaw stand according to the above aspect 9, wherein
   an inner surface of the recess has a curved shape.
11. The portable bandsaw stand according to any one of the above aspects 1 to 10, wherein
   a rubber hardness of the abutment member is 80 or more and 90 or less.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A portable bandsaw stand to which a portable bandsaw is attached, the portable bandsaw stand comprising:
a base;
an attachment arm that is swingably supported about a swing fulcrum by the base and to which the portable bandsaw is attached; and
a return device configured to automatically return the attachment arm to a top dead center.

2. The portable bandsaw stand according to claim 1, wherein
the return device includes a spring that is interposed between the base and the attachment arm, and
the attachment arm is held at the top dead center by urging force of the spring.

3. The portable bandsaw stand according to claim 2, wherein
the spring includes a torsion spring,
a swing support shaft of the attachment arm is inserted into a coil portion of the torsion spring,
one arm portion of the torsion spring presses the base, and
another arm portion of the torsion spring presses the attachment arm up to the top dead center.

4. The portable bandsaw stand according to claim 1, wherein
the portable bandsaw includes a drive wheel that is rotated by a motor, a driven wheel, and a blade that is stretched between the drive wheel and the driven wheel,
the driven wheel is disposed on a counter-user side of the drive wheel, and
the swing fulcrum is disposed on the counter-user side of the drive wheel.

5. The portable bandsaw stand according to claim 4, wherein
the portable bandsaw includes a housing that accommodates the drive wheel and the driven wheel, and a handle that is fixed to the housing, and
in a left-right direction parallel to an axis of the swing fulcrum, a position of a cutting portion of the blade with respect to the handle in an attached state in which the portable bandsaw is attached to the stand is the same as a position of a cutting portion of the blade with respect to the handle in a normal use state in which the portable bandsaw is normally used.

6. The portable bandsaw stand according to claim 5, wherein
the cutting portion of the blade is disposed leftward of the handle in both the attached state and the normal use state.

7. The portable bandsaw stand according to claim 4, wherein
the attachment arm includes a cylindrical portion that is disposed around the swing fulcrum, a first arm portion that extends from the cylindrical portion to a user side, and a second arm portion that extends upward from the cylindrical portion, and
the portable bandsaw stand comprises:
a first fastener that fixes the first arm portion to the portable bandsaw; and
a second fastener that fixes the second arm portion to the portable bandsaw.

8. The portable bandsaw stand according to claim 7, wherein
at least one of the first fastener or the second fastener is a thumb screw.

9. The portable bandsaw stand according to claim 1, comprising:
a vise that is provided on the base and fixes a workpiece; and
a fence that is provided on the base and supports the workpiece, wherein
an abutment surface, of the fence, facing the workpiece faces a counter-user side, and
the vise is disposed on the counter-user side of the abutment surface.

10. A portable bandsaw stand to which a portable bandsaw is attached, the portable bandsaw stand comprising:
a base; and
an attachment arm that is swingably supported about a swing fulcrum by the base and to which the portable bandsaw is attached, wherein
the portable bandsaw includes a drive wheel that is rotated by a motor, a driven wheel, a blade that is stretched between the drive wheel and the driven wheel, a housing that accommodates the drive wheel and the driven wheel, and a battery mounting portion on which a battery pack is mounted,
the driven wheel is disposed on a counter-user side of the drive wheel,
the swing fulcrum is disposed on the counter-user side of the drive wheel, and
the battery pack mounted on the battery mounting portion is disposed on a user side of a position that is half a distance from the swing fulcrum to a user-side end of the housing.

11. The portable bandsaw stand according to claim 10, wherein
the portable bandsaw includes a handle that is fixed to the housing, and
the battery mounting portion is provided on the user-side end of the handle.

12. A portable bandsaw stand to which a portable bandsaw is attached, the portable bandsaw stand comprising:
a base;
an attachment arm including a cylindrical portion that is swingably supported about a swing fulcrum by the base and is disposed around the swing fulcrum, a first arm portion that extends from the cylindrical portion to a user side, and a second arm portion that extends upward from the cylindrical portion;
a first fastener that fixes the first arm portion to the portable bandsaw; and
a second fastener that fixes the second arm portion to the portable bandsaw.

13. The portable bandsaw stand according to claim 12, further comprising:
a support member that is fixed to the base; and
a lock member that is movably supported by the support member and fixes the attachment arm by being inserted into at least a part of the first arm portion.

14. The portable bandsaw stand according to claim 13, wherein
the first arm portion has an insertion hole for a bottom dead center, and
the attachment arm is fixed at the bottom dead center by inserting the lock member into the insertion hole for the bottom dead center.

15. The portable bandsaw stand according to claim 13, wherein
the first arm portion has an insertion hole for a bottom dead center and an insertion hole for a top dead center,
the attachment arm is fixed at the bottom dead center by inserting the lock member into the insertion hole for the bottom dead center, and
the attachment arm is fixed at the top dead center by inserting the lock member into the insertion hole for the top dead center.

16. The portable bandsaw stand according to claim 12, wherein
the first arm portion includes a storage portion that stores at least a part of the first fastener.

17. The portable bandsaw stand according to claim 12, wherein
an outer shape of the base is rectangular in plan view.

18. The portable bandsaw stand according to claim 12, wherein
the base is made of a drawn steel plate, and
the attachment arm is made of a die-cast alloy.
